(19) United States
(12) Patent Application Publication
(10) Pub. No.: US 2026/0251950 A1
(43) Pub. Date: Aug. 27, 2026

(54) VERTICAL PHOTONIC SWITCH

(71) Applicant: Donald S. Stern, Dover, DE (US)

(72) Inventor: Donald S. Stern, Dover, DE (US)

(21) Appl. No.: 19/549,511

(22) Filed: Feb. 25, 2026

Related U.S. Application Data
(60) Provisional application No. 63/763,751, filed on Feb. 26, 2025.

(51) Int. Cl. G02F 3/00; G02F 1/29

(52) U.S. Cl. CPC G02F 3/00; G02F 1/293

(57) ABSTRACT

A method for producing a semiconductor device that uses optical pathways and optical switches within the layers of the semiconductor integrated circuit by the means of creation of optical switches, lens and reflectors using Chemical Vapor Deposition and Rapid Thermal process equipment. Using a combination of materials optical switches, lens and reflectors can create photonic circuits which can be routed through the layers of a semiconductor device much in the same way electrical circuits are routed in existing semiconductor device today.

### CROSS-REFERENCE TO RELATED APPLICATION

The present application claims the benefit of U.S. Provisional Application No. 63/763,751, filed February 26, 2025; all of which is incorporated herein in its entirety and referenced thereto.

### FIELD OF THE INVENTION

The invention relates to the fabrication of a photonic integrated circuit structure to create a photonic switch and photonic waveguides pathways used to connect the photonic switches together to create a photonic integrated circuit. More particularly is the process of building the electromagnetic or optical pathways or waveguide inside a semiconductor device to allow for a photonic radiation to be used to activate a photo chromatic switching device. In one embodiment a photo chromatic device using, a for example a EUV (Extreme Ultra Violet) light frequency is used to active, a exciton layer which acts as a switching membrane of a semiconductor film is layer upon a silicon nitride focusing lens and reflectors structures in a semiconductor. Using this exciton membrane, an optical EUV switching is created allowing EUV light to pass through the membrane used to active the next switch or blocked and reflected the electromagnetic radiation. Using these photonic switches and connecting them by routing the optical signal through optical three dimensional pathways allows an photonic circuit to be built and computer logic on a silicon wafer to replace electrical designed used today.

### BACKGROUND

Transistors are at the center of all electronic devices. Today computers contain millions if not billions of transistors. Of the types of transistors, the focus of this device is a switching device to replace the electronic transistor. Transistors contain a base, collector and an emitter. Most designs have a laid out in a horizontal format with the functional part of the transistor collector and emitter embedded in the silicon substrate using doped embedded junctions. Using the base element and applying a voltage to turn on and off the device is the standard use for computer circuits. IBM and Samsung in 2021 announced a new version of this transistor designed using a vertical design which would allow for more transistors to be put into a smaller foot print and closer together. Moving transistors closer together allows for faster signaling speeds as the electron signal between them would travel a shorter distance is a short time. These closer distances and shorter signal connections come with a tradeoff as the heat buildup from the power of switching from each transistor becomes a bigger problem. This then requires better cooling system to keep the bulk of this semiconductor from melting from the heat generated in the switching of the transistor.

Electron speed and power to switch all the millions and billions of transistors in computers chip and their heat byproduct are big factors in the design of semiconductor computer chips.

Using photons or other higher frequency signaling methods like microwaves or even x-ray’s instead of electrons allows for a much faster interconnect signaling time between these switching device. This invention uses the Photochemistry photoexcitation atomic level electron shell movement which causes the blocking of light. “Photoexcitation is the step in a photochemical process where an electron in an atom is elevated to a higher energy excited state. The first law of photochemistry, known as the Grotthuss-Draper law states that light must be absorbed by a chemical substance in order for a photochemical reaction to take place. The second law on photochemistry, known as the Stark-Einstein law for each photon of light absorbed by a chemical system, no more than one molecule is activated for a photochemical reaction, as defined by the quantum yield” (Wikipedia.org). Photochemisical Electron shell movement occurs at a much faster speed that the building of a conductive tunnel in the electrical transistor process to allow for electron or electromagnetic waves to move or flow.

Using Photochromism which is a phenomenon that produces a change in a chemical structure or lattice substance by incident radiation is a light induced change in a chemical substance and can be used in a photonic switch. Electrochromism is a phenomenon which causes a material, for example gallium arsenide, Lithium niobate, indium phosphide, tungsten oxides which can be deposited using PE CVD processes, to changes its opacity in response to electromagnetic stimulus. By using a combination of these material chemistries, then a light induced optical change allows for the blocking or transmissition of certain electromagnetic frequencies.

Digital logic circuits requires several parameters like the amount of current being switched, the voltage used to operate the device, the switching speed or propagation time for the input base to rise or fall to effects the switching of the device. Similar design parameters in a photonic device are required for the electron movement speed between shells, the propagation time for light to be routed through a optical pathway, the energy levels on focal points used to produce the correct level of light, the propagation switching time to allow for the electron to relax and return to its normal shell level and the heat byproducts of the reflected light energy not used for switching in terms of photon flow and switching times for the device need to be considered.

The energy used to operate the switching of an electronic transistor cause heat to be generated in the device and a buildup of this heat energy causes many problems including the device becoming so hot it melts and fails. Using photons instead of electrons to switch the device will require much less energy and reduction heat in the device and a much lower power requirement for issue like portable devices, battery size and device life.

The speed to transmit signals between device elements is needed to allow for faster computers and a solution as to the heat byproduct is required. Using photons to replace electrons would be a large step to speeding up the signal processing and would also reduce the heat byproduct and thus solve many of design, packing and operational problems limiting that existing in Semiconductor computer systems today.

The noise issues experienced by today’s electronic circuits with electromagnetic cross talk in which the electromagnet field cause electronic signals to be induced into adjacent circuits cause noise and error’s to occur in the circuits. Moving away from this electromagnetic noise problem by using photons to replace the electrons and light pipes instead of wires will greatly reduces this issue and simplifies the circuits used inside of the chip. Items like capacitors and resistors will be eliminated from circuit designs as the use of these components to reduce noise; inductive signal effect and reflected signal are greatly reduced if not completely eliminated in some cases. The reduction or elimination of reflected electronic signals on ground planes is another large issue in electronic circuit designs and using a photon base signaling system will reduce or eliminate these noise issues. This approach also has a protection as a photonic circuit is immune from Electromagnetic pulses (EMP) and other damaging radiation effect which damage traditional electronic base technologies.

The step from electronic transistors to photonic transistors will reduce the fabrication steps from a horizontal format transistor to a vertical optical switch format and will allow for a faster and easier fabrication process. For example the need for ion implanters will be eliminated.

As the speed of a photonic circuit uses the speed of light and not the speed of electrons then a computer system using this technology along with AGI (Artificial General Intelligent) would be able to out thing a human mind by many times.

### SUMMARY

In accordance with the invention, a semiconductor substrate is used as a base without the need for an ion implanter for the embedment of transistor doped gates. A light pipe base or an embedded LED (light emitting diode) light source with layers of opaque and reflective materials are used to direct photonic signals to connect the photonic device elements. Photonic device gate elements are routed using electromagnetic or optical pathways between the photonic gate elements. Using multiple layers of light pipes to direct light in much the same way as the layers of electron wire conducts crisscross across a chip surface connecting electronic gates and device elements. Using reflector (like a Bragg reflector) or frequency tuned mirrored surfaces to route light around right angles / corners from horizontal to a vertical light pipes and back again, allows photonic device interconnection of switching photonic gate elements. For example, in one embodiment, the use of a Bragg layered for example using aluminum deposited using Chemical vapor deposition system using an aluminum (Al) films by deposited reflector by using a Dimethyl Aluminum Hydride (DHAH) or Triisobutylaluminium (TIBA) in much like a TEOS (Tetraethyl orthosilicate) is used in a DF RF CVD system with a carrier gas of H2 as an inert carrier gas structures. Other material can be deposited to allowing for the direction of the light to be reflected from different layers within the Semiconductor chip. Other embodiment can use material like tungsten, molybdenum or similar wavelength reflective material of a combination of these types of wavelength specific reflective materials for reflecting UV or EUV photons wavelength frequencies would matching the material troughs or via as reflective sides surfaces can be used then a wavelength transparent material. In another embodiment for example a silicon nitride, which allows for the wavelength frequency specific material can be used for a photonic UV signaling pathway guide inside the trough can be built as a electromagnetic or optical pathways. In one embodiment a concave shape or semi-circle or dome shaped structure can be used to reflect the light. When the pathway need to change levels within the layers of the semiconductor then a curved (concave or quarter-circle or half dome or arced or arched shaped surface) reflector or mirrored surface with a defined radius and focal point can be deposited at the bottom of the via where the horizontal pathway intersects with a vertical pathway.

At the top of the via another reflective surface can be created by using Plasma Rapid Thermal Processing (PRTP). In one embodiment a layer of tungsten may be applied to protect the underlying material below the protruding transparent material but not covering the protruding element as the melting temperature of tungsten is much higher than the silicon nitride and other materials. The tungsten or other material deposited across the surface of the wafer blocks the RTP plasma from melting any other part of the device. This annealing in a low vacuum with a wavelength transparent material allowing for the PRTP annealing temperature of the material (for example 1,900deg C for silicon nitride) to cause it to melt. As the material melts the surfaces tension of the material will cause the material to form a dome shape. In one embodiment half of this dome shape is removed or etched away and a new layer pathway created with a reflective trench using a wavelength compatible silicon optical conductor with a wavelength frequency material thus creating a right angle reflector from the via to the desired layer within the integrated device to a intersecting horizontal pathway can then be routed to direct the signal to the desired location to interact with an active photonic switching element.

The layers will also include a switching photochromic light gate used to switch the photochromic gate on and off. This allows the photochromic gate to be built using standard semiconductor layer processing equipment inducing photonic light into the photochromic layers of the photonic switching gate. This design and layered process allows for vertical photonic transistor to be built. Using tuned photonic light frequencies, the photochromic gate layer can be tuned to switch between opaque and transparent states at different speeds. Issues like optical Stark effects can affect switching speed and performance. The photonic induction process causes the photochromic layer to change as the gate causes electrons in the photonic gate to move from lower shells to higher shells caused by the induction contribution to the resonant frequency of the photochromic layer. Many different combinations of photochromic layers chemistries can be used to create this photonic inductive layer to cause the transparency of the layer to change as the electrons changes shells in the layered materials. The switching surface of the photo chromic layer is the key to building a switching device. The ability to impact the entire surface equally in parallel with photonic radiation at one time requires a dome or curved or concave shaped layer of the photochromic material. Structures like grading which cause photonic waves effects and delays in the switching speed are not used. The intersection of a photonic source (like a transistor base) for example in one embodiment, using an side opening into a via which intersects with a half dome concave lenses with a photochromic coating layer in the via, allows for the photon source (like a transistor emitter electrical source) to switch and either allow by becoming optical transparent or opaque, blocking the photonic source. The switching base combines with the additional switched photonic source going through a polarized lens structure to cause a focal point upon the next switch (like a transistor collector) to continue through the photonic pathway to the next photonic device and becomes the switching input (base) for that optical switch. The use of polarized slit like filter layer on the photochromic layer also allows for a diode or one way light direction.

The use of photonic switches and the pathway connections allows for an array of logic devices like AND, OR, NOT and flip flops just to name a few already know in the arts to be designed, layout, simulated, and verification using existing semiconductor layout tools and equipment already in the fab’s today.

SPEED of SIGNALING. - The speed of signals between the active devices on an integrated circuit is one of the limiting factors in circuit design. Issues like the race condition or signals arriving at different locations because of the path length being routed across a chip surface and the speed of electrons and the resistance of the material they travel through traces cause circuit and logic errors. The use of photons instead of electrons will reduce if not eliminate many of these issues.

In an electrical signaling system you have to calculate the wire path length and resistance of the material along with other factors such as electronic inductance and signal capacitive cross talk, electrical standing waves reflections which cause attenuation, noise and other interference factors from other sources in electrical signals. In a photonic signal system speed is also affected by length of the pathway, material impurities, and material reflections like standing waves reflections which causes signal attenuation and noise. Still comparing the electrical signal to the photonic signal the photonic signal is at least many times faster and much more noise free. One of the many reasons the world is moving from wires to fiber optical internet connections.

SPEED of SWITCHING - The speed to switch a transistor is based in part on the size and type of material used in the tunnel junction between the emitter and collector (cathode and the anode) to a transistor. The amount of charge across the base and the voltage ramp and current flow will cause the device junction to reach a threshold level that allows for the flow of electrons across the junction and thus switch switches on or off. This junction capacitive value can be calculated as the time for the change across the capacitive area to become saturated and thus allow for electron flow. This saturation value is a factor of time verses capacitive surface area. Between the charge time or base rise time and electron flow can be a relative long time causing propagation delays times in the circuit. The switching times of typical electronic transistors can be anywhere from 1 Mega hertz (MHZ) to 800 gig hertz (GHZ) or in nanoseconds (0.0000000001) or one billion time per second or 1x10 -9.

Switching speed of a photonic switch requires the movement of electrons in an atom to move from one shell orbit to another higher shell orbit. This movement occurs in theory at the speed of light and according to U of Arizona paper at petahertz or attoseconds (0.0000000000000001) or one quintillionth of a second or 1x10 -15.

The difference in switching speed is at least 1,000 (thousand) to over a 1,000,000 (million) times faster. One of the issues is that the current measurement tools and equipment are not fast enough to measure this signal change and the switching time appears as an instance change in levels. The same affect occurs in the photochromic layer or junction which also requires for the switching surface to reach a saturation level and where a surface cascade effect can occur which causes the surface of the photonic switch to change or twist or transform and switch from a wavelength specific transparent frequency surface to an opaque layer to either allow the light to pass or be blocked.

SWITCHING LOGIC - A transistor uses positive switching where applying voltage to the base turn on the switch. The photonic switch is a negative switching device were the applying of the photonic input source causes the switch to switch off or block the photonic stream. By applying a set of photonic switches then a positive logic switch can be recreated to allow existing positive logic circuits to be easily transferred to this fabrication process.

In one embodiment, the device includes a tunnel shaped horizontal light pipe element that is located in an interior layer defined by a pathway first element. An electromagnetic source or a EUV light source is mounted in a reflector concave shaped element at the bottom of a via which emits and reflects light vertically up the via through light pipe that intersects with a photochromic layer. This concave shaped lens is intersected by the switching signal light pipe which comes from another layer. This switching source causes the switch layer to become either opaque or transparent which turns on or off the photochromic layer. This switching layer changes states and allows for the electromagnetic signal in this embodiment a EUV light to continue through the optical pathway or be blocked from going up a vertical light pipe to another reflector formed on another layer causing the light to be directed to another device layer element. This optical switching effect causes a transistor like gate switching device to operate. A photochromic inductive capacitor that includes an optical trap material between the two elements is also referred to as an “photonic transistor inductive capacitor gate.”

As the photochromic layer is in the shape of a concave half dome then the input switching base source is equally distributed across the entire switching surface. This allows a parallel reaction to occur across the entire surface. As an electronic transistor switching junction occurs is a serial surface effect as the base capacitive surface is changed and a tunnel junction is formed in a serial electron path. The curved surface of the Photonic switch allows the entire surface of the switch to be affected in parallel for a much faster switching process to occur.

### BRIEF DESCRIPTION OF THE DRAWINGS

FIG. 1A Illustrates one embodiment of a NOT GATE Vertical Photonic switch structure.

FIG. 1B illustrates a block diagram of a computer system built with photonic components in accordance with the invention.

FIG. 2A is the logic symbol for a NOT gate (Prior Art).

FIG. 2B is a NOT gate truth table (Prior Art).

FIG. 2C is a NOT gate electrical schematic (Prior Art)

FIG. 2D is a NOT gate CMOS electrical schematic (Prior Art).

FIG. 2E is an abstract semiconductor layout of a NOT GATE CMOS transistors structure (Prior Art).

FIG. 2F illustrates one embodiment of a NOT GATE Vertical Photonic switch schematic in accordance with the invention with a new symbol for a Photonic switch device.

FIG. 2G is one embodiment of a NOT gate signal going from a horizontal layer to vertical via through a Photonic switch layer and reflecting to another horizontal layer to form an interconnect device with the photonic switch on to allow for the photon flux to pass through the switch layer.

FIG. 2H is one embodiment of a NOT gate photonic switch interconnect waveguide pathway with a focal point shown intersecting the photonic switch layer with the Photonic switch off and blocking the photon source from passing through the switch

FIG. 3A is a logic symbol for a AND gate (Prior Art).

FIG. 3B is a AND gate truth table (Prior Art).

FIG. 3C is one embodiment of a Photonic AND gate the two input signals both zero with the photonic switches vertical stacked going from a horizontal layers to vertical via through a Photonic switch layer and reflecting to another horizontal layer to form an interconnect device with the photonic switch on to allow for the photon flux to pass through the switch layer and the result signal Q is zero.

FIG. 3D is one embodiment of a Photonic AND gate where the two input signals where the A signal is zero and the B signal is one going from a horizontal layers to vertical via through a Photonic switch layer and reflecting to another horizontal layer to form an interconnect device with the photonic switch on to allow for the photon flux to pass through the switch layer and the resulting signal Q is zero.

FIG. 3E is one embodiment of a Photonic AND gate where the two input signals where the A signal is one and the B signal is zero going from a horizontal layers to vertical via through a Photonic switch layer and reflecting to another horizontal layer to form an interconnect device with the photonic switch on to allow for the photon flux to pass through the switch layer and the resulting signal Q is zero.

FIG. 3F is one embodiment of a Photonic AND gate where the two input signals where the A signal is one and the B signal is one going from a horizontal layers to vertical via through a Photonic switch layer and reflecting to another horizontal layer to form an interconnect device with the photonic switch on to allow for the photon flux to pass through the switch layer and the resulting signal Q is one.

FIG. 4A is a logic symbol for a NAND gate (Prior Art).

FIG. 4B is a NAND gate truth table (Prior Art).

FIG. 4C is one embodiment of a Photonic NAND gate the two input signals both zero with two of the Photonic gates vertical stacked and a third gate horizontal optically connected with the inputs going from a horizontal layers to the vertical via through a Photonic switch layer and reflecting to another horizontal layer to form an interconnect device with the photonic switch on to allow for the photon flux to pass through the switch layer and the result signal Q is one.

FIG. 4D is one embodiment of a Photonic NAND gate where the two input signals where the A signal is zero and the B signal is one going from a horizontal layers to vertical via through a Photonic switch layer and reflecting to another horizontal layer to form an interconnect device with the photonic switch on to allow for the photon flux to pass through the switch layer and the resulting signal Q is one.

FIG. 4E is one embodiment of a Photonic NAND gate where the two input signals where the A signal is one and the B signal is zero going from a horizontal layers to vertical via through a Photonic switch layer and reflecting to another horizontal layer to form an interconnect device with the photonic switch on to allow for the photon flux to pass through the switch layer and the resulting signal Q is one.

FIG. 4F is one embodiment of a Photonic NAND gate where the two input signals where the A signal is one and the B signal is one going from a horizontal layers to vertical via through a Photonic switch layer and reflecting to another horizontal layer to form an interconnect device with the photonic switch on to allow for the photon flux to pass through the switch layer and the resulting signal Q is zero.

FIG. 5A is a logic symbol for an OR gate (Prior Art).

FIG. 5B is an OR gate truth table (Prior Art).

FIG. 5C is one embodiment of a Photonic OR gate the two input signals both zero with two of the Photonic gates vertical stacked and a third gate horizontal optically connected with the inputs going from a horizontal layers to the vertical via through a Photonic switch layer and reflecting to another horizontal layer to form an interconnect device with the photonic switch on to allow for the photon flux to pass through the switch layer and the result signal Q is zero.

FIG. 5D is one embodiment of a Photonic OR gate where the two input signals where the A signal is zero and the B signal is one going from a horizontal layers to vertical via through a Photonic switch layer and reflecting to another horizontal layer to form an interconnect device with the photonic switch on to allow for the photon flux to pass through the switch layer and the resulting signal Q is one.

FIG. 5E is one embodiment of a Photonic OR gate where the two input signals where the A signal is one and the B signal is zero going from a horizontal layers to vertical via through a Photonic switch layer and reflecting to another horizontal layer to form an interconnect device with the photonic switch on to allow for the photon flux to pass through the switch layer and the resulting signal Q is one.

FIG. 5F is one embodiment of a Photonic OR gate where the two input signals where the A signal is one and the B signal is one going from a horizontal layers to vertical via through a Photonic switch layer and reflecting to another horizontal layer to form an interconnect device with the photonic switch on to allow for the photon flux to pass through the switch layer and the resulting signal Q is one.

FIG. 6A is a logic symbol for a NOR gate (Prior Art).

FIG. 6B is a NOR gate truth table (Prior Art).

FIG. 6C is one embodiment of a Photonic NOR gate the two input signals both zero with two of the Photonic gates vertical stacked and a third gate horizontal optically connected with the inputs going from a horizontal layers to the vertical via through a Photonic switch layer and reflecting to another horizontal layer to form an interconnect device with the photonic switch on to allow for the photon flux to pass through the switch layer and the result signal Q is one.

FIG. 6D is one embodiment of a Photonic NOR gate where the two input signals where the A signal is zero and the B signal is one going from a horizontal layers to vertical via through a Photonic switch layer and reflecting to another horizontal layer to form an interconnect device with the photonic switch on to allow for the photon flux to pass through the switch layer and the resulting signal Q is zero.

FIG. 6E is one embodiment of a Photonic NOR gate where the two input signals where the A signal is one and the B signal is zero going from a horizontal layers to vertical via through a Photonic switch layer and reflecting to another horizontal layer to form an interconnect device with the photonic switch on to allow for the photon flux to pass through the switch layer and the resulting signal Q is zero.

FIG. 6F is one embodiment of a Photonic NOR gate where the two input signals where the A signal is one and the B signal is one going from a horizontal layers to vertical via through a Photonic switch layer and reflecting to another horizontal layer to form an interconnect device with the photonic switch on to allow for the photon flux to pass through the switch layer and the resulting signal Q is zero.

FIG. 7 is one embodiment view of a cluster of photonic switch structure with multiple photonic switches and multiple reflectors.

FIG. 8 illustrates a photonic pathway showing a photon stream moving vertical up a via with reflective sides to a concave reflector A and reflected to a photonic horizontal photonic pathway with reflective sides to another concave reflector B being reflected down a vertical photonic via pathway with reflective sides to intersects with a concave reflector C to continue to interface with a either a photonic device input or another photonic pathway.

FIG. 9A-G shows a sequence of drawings showing via filling process to create a right angle concave layer to create via reflector or a right angle reflective surface to create a light pathway.

FIGS. 10A-O shows a sequence of drawings showing the creation of a semiconductor via construction process to create a right angle concave layer to build a vertical Photochromic switching layer.

### DETAILED DESCRIPTION

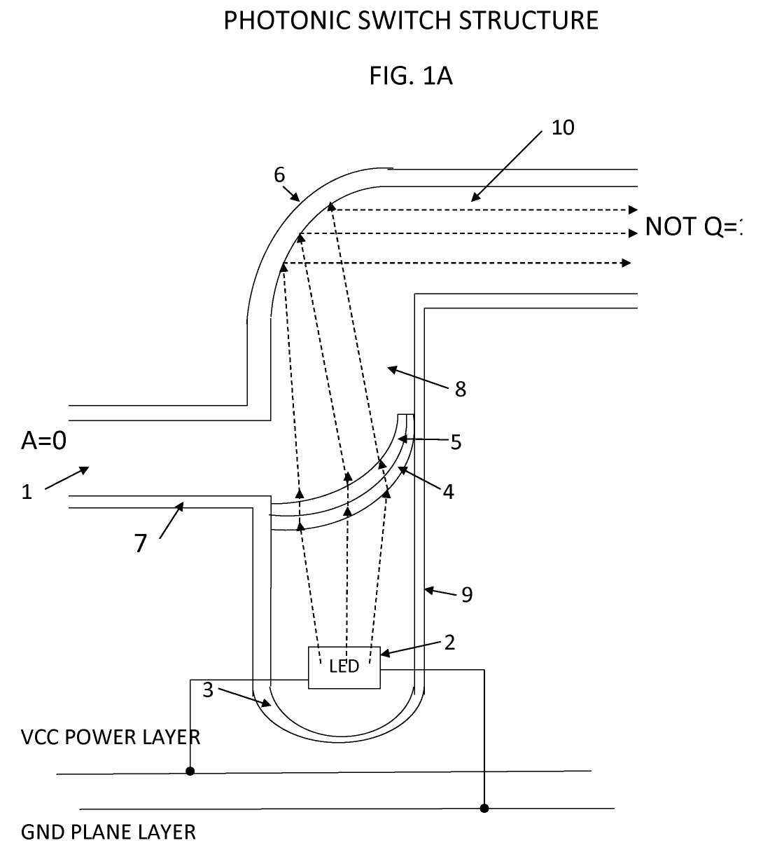

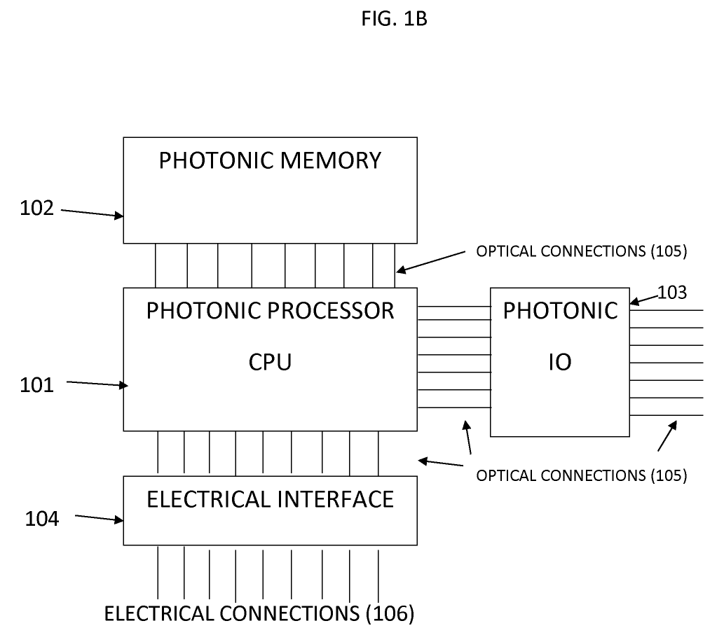

FIG. 1A illustrates one embodiment of a simple NOT gate vertical Photonic switch. A semiconductor side view is shown in accordance with the invention. This embodiment formed a photonic switching a device in which a first input electromagnetic or light pathway element 1 of a photo transparent material for example Silicon Nitride as an example is layered with a second element 7 a photo reflective element like aluminum (AL) or molybdenum (Mo) material or other wavelength specific reflective materials.

As would be apparent to the skilled artisan, a first element 1 layer surrounded by or in a sleeve or tunnel and in between mirrored reflective elements 7 causes a wavelength pathway used for routing optical light, like UV ultraviolet light, infrared light or other frequencies of electromagnetic frequencies between other components in a photonic switch.

The invention allows for the electromagnetic pathway or waveguides 1 to be built within an integrated semiconductor to allow for photonic photo chromic logic elements 5 to be intersected or connected within the device. In this embodiment EUV (Extreme UltraViolet) photonic light (for example 10 to 100 nm) is uses as a source for the electromagnetic radiation used for signaling. In another embodiment a design for different frequencies of electromagnetic radiation may be used for example terahertz microwave waveguides and X-ray radiation waveguide at a higher wavelength frequency which would provide for a smaller and faster interconnect signal pathway.

FIG. 1A shows a side view diagram of photonic photo chromic switch structure 5 semiconductor layer to intersect with a via 8 with a half dome concave photonic switch structure 5 to allow the electromagnetic signal to interact or shine on a frequency specific material 5. This intersection allows for the signal source 2 and go either go up the via or down the via to another semiconductor layer where another reflector 6 causes the signal to again change direction and turn to continue through to the next electromagnetic or optical waveguide. A electromagnetic or light source 2 is positioned in a via 8 to prove a constant source of electromagnetic energy and is reflected off the bottom 3 of a concave reflector and sides walls 9 of the via to provide a source of electromagnetic energy much like a transistor source. This source can be either a constant source 2 like the Vcc voltage source applied from a transistor or a switched source which may be the output of another photonic switch output 10. The output from this source can be either a constant source or an input from an electronic source switching the source on and off to provide signals to the switch. The electromagnet light travels up the via 8 and through a photonic polarizing filter 4 which collimates the source (i.e. like a light slit or a hole in the filter material) and causes the signal to pass through the switch layer 5 without causing the switch to be activated. The signal then continues in the vertical via 8 to a reflector 6 which reflects the electromagnetic signal to reflect into a horizontal waveguide or tunnel 10 to connect to the next photonic device component or to a transceiver to be converted into an electrical signal.

The switching signal arrives in waveguide 1 and enters via 8 to intersect with the photochromic layer 5. This electromagnetic signal (i.e. much like a gate or base of a transistor) is used to turn on and off the photonic switch layer 5. As the signal 1 intersects with the photo chromatic frequency sensitive light sensitive layer 5 it causes the photochromic material to change in an exciton reaction process where the photons interact with the atoms of the structure and the material absorb the photon energy. The photochromic layer is curved to allow for the input photons 1 to contact the entire surface of the photochromic layer in parallel.

In semiconductor the laminar flat surfaces are not at an angle. For the photonic input signal to affect the complete surface in a parallel process a different structure is required. An example is the grading structure used in many other prior art photonic patents where the photonic signal effect a flat or a tooth like surface but the exciton effect is not enough to cause a switching effect until a photon electric buildup or a wave front is created to cause the change in the conductance or reflection of the signal. This slow absorption or buildup of exciton material delays the changes switching effect in a device. The follow on deactivating process is a slow release of photonic energy through photon release cause a very slow delay reaction in a device as described in prior art and an optical Stark effect.

In this embodiment using a curved, semi curved or half dome structure is used where the photonic energy is equally distribution across the entire surface in parallel. Each photochromic element in the layer absorbs the photonic energy in parallel and a cascading event to occur across the entire surface as a single photonic event. This allows for a large photonic surface to react in the time for a single electron to change its shell and occur in altosecond time frame.

This invention disclosed the use of curved surfaces not commonly used in flat laminar semiconductor film processing. Figures below disclose embodiments of the use of semiconductor processes which can create these curved structures for use as optical lens, reflectors and photonic switching surfaces.

This parallel surface affect causes a parallel cascade effect on the photo chromic surface. In this process electrons are driven from their natural atomic shell orbit to a higher shell. This photon absorption causes the lattices in the material to change and convert from an electromagnetic transparent material to an electromagnetic reflective material thus blocking structure which blocks the electromagnetic source 2. The resulting electromagnetic signal 10 is then turned off or blocked. This parallel cascade switch occurs at a high speed unlike a transistor tunneling process where the switching tunnel capacitor must charge over time (i.e. switching time).

FIG. 1B is a block diagram example is one embodiment of a Photonic integrated circuit (PIC) computer chip. The first block 101 is a photonic processor with several photonic components like a clock circuits used for timing of the different components to be synergized together. Several logic blocks made up of photonic circuits are used to form AND, NAND, OR and NOR gates used to building logical blocks like a arithmetic logic unit, Floating point unit, registers, cache memory, input and output register shift registers, buffer circuits and many other types of logic blocks used to process computer instructions and communicate to other device that may be attached to the chip. The Photonic chip 101 can use either an electrical or optical (photonic) connection interface 105 or BUS (Binary Unit System) to connect to other components like memory were the computer instructions and data to be processed are stored. The Photonic memory 102 is a component that can be either part of the chip or die or an external chip or die connected using a photonic optical path 105 using light as a signal source for very high speed data transfer. Additional components like a photonic input and output module 103 which could be part of the die chip or a attached die is used to communicate with other processor chips or other specialized chip through a optical interface connection 105 like a network transceiver for fiber network communication or control unit interface chips for example a external storage device like a hard disk, memory card, network adaptor or modem, or other device like a mouse, printer, video screen controller, and many other device that attach to a computer system. The photonic processor 101 can also have an optical interface 105 or an electrical interface component 104 that is used to connect and communicate with other electrical device components that use electrical signal (voltage and current) 106 interfaces to electrical device for signal and data transfer. The electrical interface 104 can also be used for control and distribution of power from a power supply for the different components and for other input and output interfaces like digital signals and analog signal to allow these signals to be converted to photonic signals for faster processing and storage by the by the photonic components.

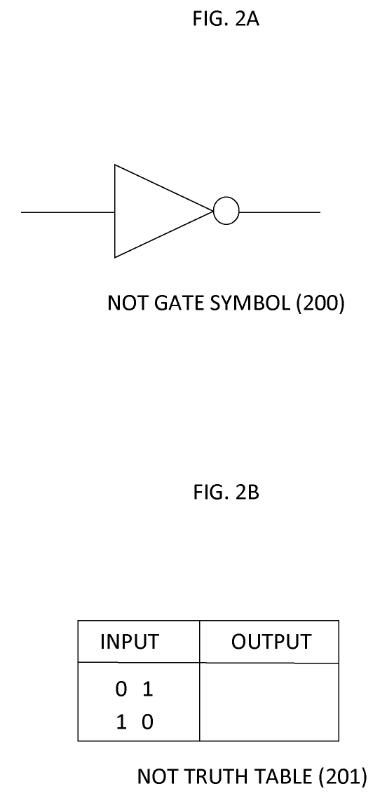

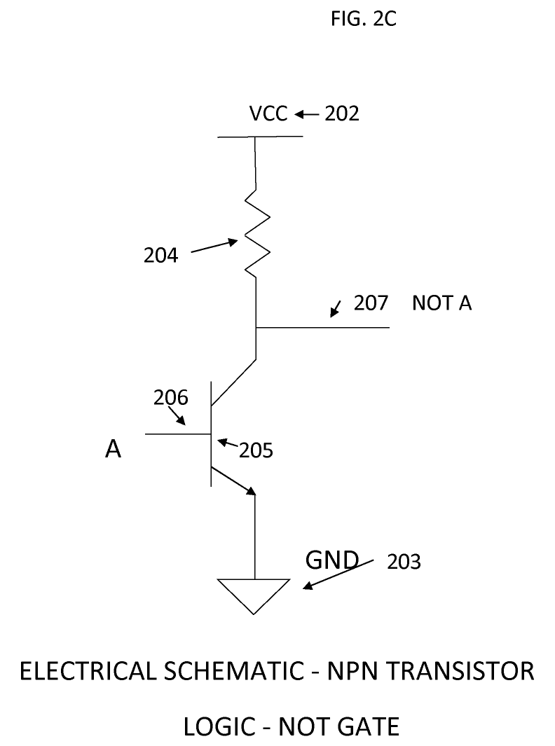

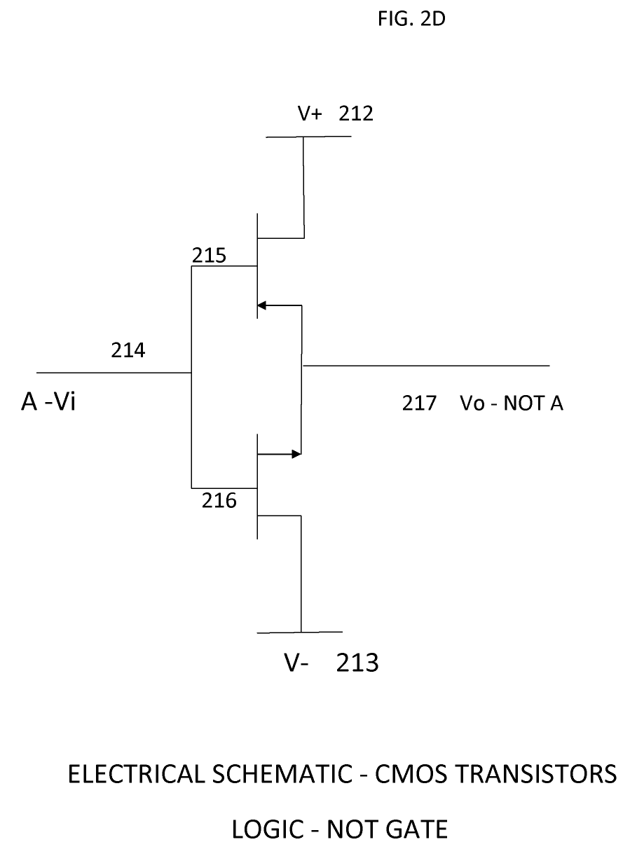

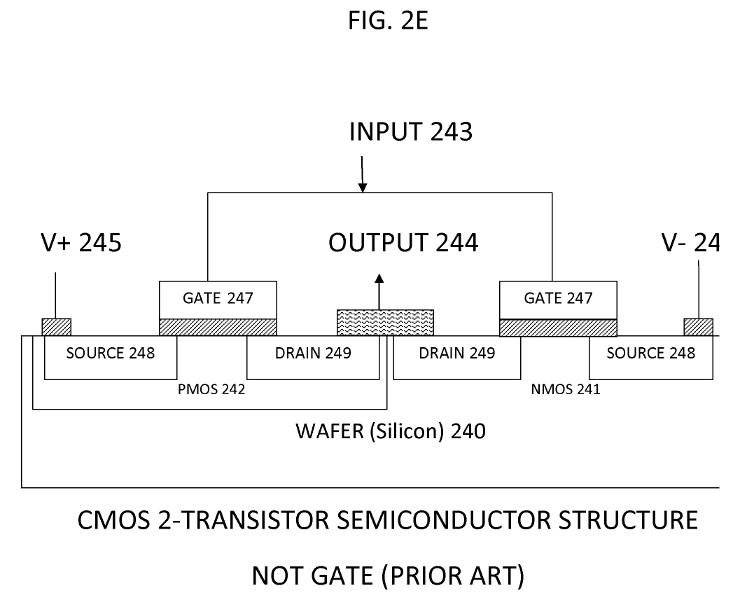

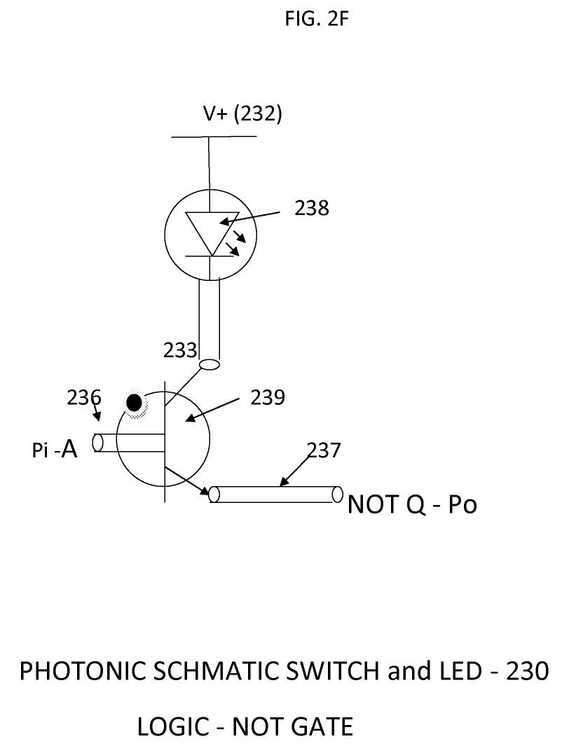

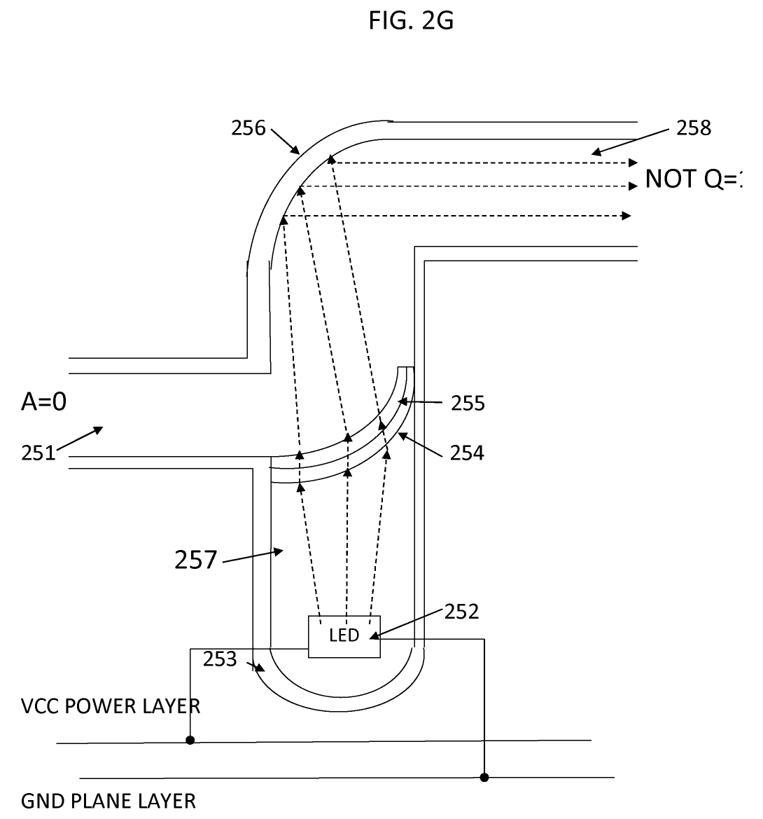

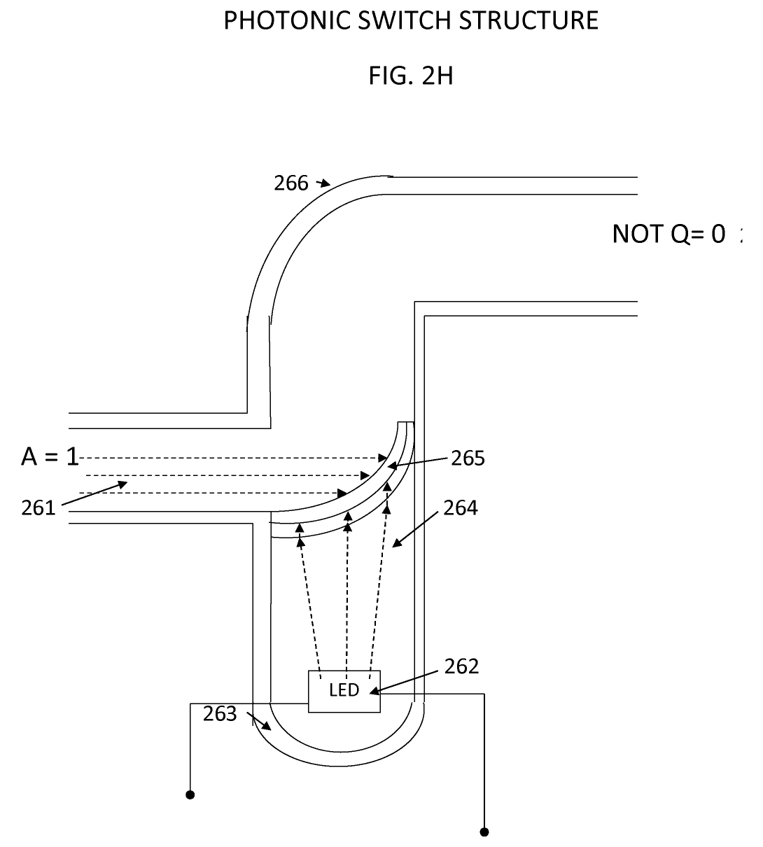

FIG. 2A shows logic NOT gate 200 (Prior Art) which is one of several basic Boolean logic functions. Using these base logic gates for example NOT, OR, AND, NAND, NOR, exclusive or XOR, exclusive nor XNOR are part of the standard eight functions uses in digital design. By using these basic building blocks then combinations of these gates then computer functions like flip flops, buffers, adders, shifter and many other circuits types can be created.

A chip designer uses these basic logic functions along with their truth tables FIG. 2B 201 which allow for the binary input and outputs signals to be understood. When designer uses Electronic Design Automation (EDA) software tools like Cadence, Synopsys Siemens (Formerly Mentor Graphics) software to design, verify, simulate, format and layout the schematics then these tools create semiconductor process masks and steps sequence for building the integrated circuits or system on a chip (SOC) components. The software will create the special layout files used by the semiconductor machines to build a semiconductor chip. These tools also use simulation programming to simulate, verify and test the circuits. This simulation and circuit verification requires the programming of the way the transistor electrical components interact and the resistive and capacitive signal speed through the electrical pathways. In a Photonic circuit additional photonic programming will be need to add this photonic pathways speed for verifying signal race conditions and for the photo chromic switching delays and other reflected photon signaling effects.

The semiconductor mask for each layer of the chip is used in the lithography process step. The basic process steps or recipes for each step Deposition, Photoresist coating, Lithography, Etch, Implantation and die cutting and packaging are all the files outputted from these software tools. Additional programming is required for these software tools to allow for additional photonic process steps for example the building of curved or quarter-circle or half dome structures reflectors, lens and photo chromic layers to simulate and verify reflector and Len focal lengths, photon flux level and signal reflection to name a few.

Design issues for example that are needed are the photonic switching times that occurs in the photochromic layer or junction. The timing simulation and verification of the switching surface to reach a photon saturation level and where the surface cascades causing the surface of the photonic switch to change or twist or transform and switch. The wavelength specific transparent frequency surface changing to a opaque layer to either allow the light to pass or be blocked and the return of the witching layer back to its transparent state needs to be calculated and verified for the operation of the photonic device.

FIG. 2B the truth tables 201 from each logic gate are used by these software tools to build simulations of the chip logic and allow for the hardware simulation to virtual run the chip and verify and check it input and output functions. As one embodiment of the photonic switch used a negative switch logic additional programming will be required to be added to the software tools to properly simulate and verify the photonic circuits.

FIG. 2C shows a simple NOT gates electrical schematic where the power VCC 202 input to the circuit. A resistor 204 is used to limit the power to the transistor 205 as to not overload it electuary and cause it to overheat and burn out. In some prior art the connecting metal line width and lengths are used to create this resistor function 204 and sometimes other semiconductor materials are used with known dielectric values. The power then enters the transistor source or collector which depending upon the type of transistor NPN or PNP allows the power to be stopped. When power is applied to the base 206 or gate of the transistor then the transistor will switch or turn on and allow the power from the source to pass through the transistor and exit the drain. This single transistor gate is modified by adding an additional complementary transistor to remove the resistor to reduce the power requirements of this gate.

This CMOS two transistor configuration requires twice the semiconductor surface size on the wafer or device die. In the photonic switch this surface area is reduced by as much as six times saving die area and reducing cost as shown in FIG. 1a.

In the semiconductor manufacturing process the different type of semiconductor materials are created by mixing or implanting other type of chemical substances. This process of doping or implanting causes the silicon to change its electrical conduction properties and is the basic formula for creating transistors. In the photonic switch this implant step is no longer needed saving process time by skipping these steps and processing equipment cost and implant material cost savings.

When the base 206 of the transistor 205 for example in FIG. 2C (A) which is the electrical input to the transistor switch has power or voltage applied then a conductive tunnel is created between the source or collector and the emitter or drain of the transistor and the transistor is switched on. When the power or voltage is removed from the base ((A) 206 then the conductive tunnel collapse and the electron flow is stopped and the transistor 205 is turned off.

In FIG. 2C the output 207 of the circuit is show as the NOT a line and when the base 206 of the transistor 205 is off the power flows through the resistor and out the output line 207. When the base 206 is energized or turn on then the power will reroute through the transistor 205 and exit the drain 203 or bottom line in the figure to the ground and thus complete the electrical circuit.

In FIG. 2D a prior art CMOS configuration of complementary field effect schematic circuit is shown with two transistors. The input voltage V+ 212 enters the first transistor 215 source. The base or Gate input 214 is connected to both transistors allowing them to switch together as one turns off the other turns on. This allows the power to not continue to flow through both transistors all the time as only one of the transistors is on. This saves power and reduces the heat that a resistor of the prior circuit would create. The output of this circuit 217 Vo is then connected to either V+ or V- or ground depending on the Vi 214 input signal creating an opposite effect.

FIG. 2E is an example (US patent 3,356,858) (prior art) of a CMOS semiconductor physical layout of a NOT logic gate which is created from the semiconductor software layout tool. The silicon wafer 240 starts as a silicon crystal flat surface. The process instructions from the layout software tool start the first step using the mask generated by the layout software to create an area that will be exposed for the implanter to, in this prior art example the NMOS area 241 is implanted to create a large area with an N-type NMOS region. The next step requires implant of a P-type PMOS material area in the wafer surface 242. The photoresist coating is applied and the lithographic process steps are used to allow the implanter to uses one of several materials for example Boron, Phosphorus or Arsenic or other similar material and accelerates the material onto the wafer surface thus implanting and doping the area 242 of the wafer. Next the photoresist coating is stripped the same steps of photoresist, lithographic and implanting are used. Once complete then the source 248 regions for the transistors are masked and implanted and finally the drain 249 area is implanted. The next process step is to apply a layer of dialectic over the surface and then mask and build the transistor base gates 247. The finals process steps will be to added dielectric material layers and then metal layers 245 246 244 243 to connections the transistor areas using the next masks to etch holes or via through the dialectic material to allow for a metal depositing to occur to the contact points on the transistor to for each metal layer needed. These metal layers are separated by insulators or dielectrics layers will be layered one on top of each other for example the power V+ layer 245 then the V-/Vo/ground layer 246 then the input layer 243 which will go to other components contact area or connection pads on the surface of the wafer to attached it to external input pins and the output layers 244 for the resulting logic out to be connected to other components or output pads to the attached to the chips pins.

In FIG. 2F is a schematic photonic switch 230 is shown. The power supply V+ 232 or source for the switch is the light created by and LED (Light Emitting Diode) 238. As this light is controlled by the voltage level 232 applied to the LED.

In this embodiment of a NOT gate the light or electromagnetic source 238 is always on and enters the photonic switch 239. The light then passes through a polarize filter and then if the input A 236 is not enabled or off then passed through the photochromic or photo switch layer and then out the NOT A output 237. The signal is inverted or NOT LOGIC as input equals 0 and output equals 1. When the input 236 light is turned on or energized then the light enters and shines on the photochromic layer which cause a photochromic reaction and the photochromic layer absorbs the photons and stops the source light from shining through which cause the output 237 NOT gate output Q to turn off.

FIG. 2G is one embodiment of a photonic NOT gate where the base reflector 253 would be built by first applying a photoresist layer and masking a via or hole to allow for a deposition of a wavelength reflective semiconductor material. This could be a wavelength specific reflective material to build a concave dome structure or a silicon or silicon nitride with a mixture ratio to allow for the signal frequency of other like material with a final coating of a electromagnetic reflective material depending upon the electromagnetic frequencies that will be used for the signaling to reflect the source light into a waveguide to be built in the via. As before in the semiconductor process steps the photoresist is stripped and the next photoresist layer and lithographic mask is applied. This layer is a photonic transparent waveguide via 257 with side walls deposited with wavelength specific reflective material to allow the photons to reflect off the via walls. The next layer created with a larger via in which a dome shaped deposited to form using polarizing filter 254 for the electromagnetic frequency. Half of this dome structure is then etched away using another mask to allow for the etching process to remove half of the dome allowing for an input opening 251. The same mask process is repeated again this time to allow a photochromic frequency sensitive material 255 to be deposited in the half dome shape structure and again using another mask is etched away leaving half the dome shape. Another mask is used to etch the sidewalls of the via to allow a reflective material to be deposited around the via except where there is an opening for the input tunnel. During these same layers the input waveguide 251 is also created with a bottom layer of electromagnetic reflective material for example in the embodiment of a EUV light the use of for example aluminum, molybdenum or tungsten or a layer of the combination are used. The input waveguide 251 can be deposited using for example a silicon nitride and the side walls can be etched and reflective material deposited for the construction of the sidewalls of the waveguide. A mask to allow for the top reflective layer is added to complete the input waveguide. Then next layer is then added by depositing a new layer of silicon nitride and another masking process sequence is then done to add the reflective sidewalls of the via. This silicon nitride is then etched back but leaving a stub or tower of silicon nitride and a layer of for example tungsten is added to protect the wafer from the next process step. A Plasma Rapid Thermal Process (PRTP) step is performed causing the top of the silicon nitride to melt and become dome shape or round or ball like structure. The next mask of silicon nitride to then connect one side of the dome structure as an gate output 258 to be extend to connect to the next device input or source for another photonic switch or other component as per the logic design and layout of the circuit requires. Another mask process would then etch and add the top reflector deposit material to allow for light signal to reflect from the vertical via to a horizontal connection 256 and the sidewalls and top of the output waveguide 258 can be deposited and completed.

As there are many process steps involved then the design software may find new ways to optimize the sequence steps and other embodiments and sequences may be used to shorten the wafer process steps. FIG. 2g is shown as the input 251 with a zero or no light input which allows for the light source to pass through the photochromic layer 255 and reflect of the top reflector 256 and produce a positive or one signal output in this embodiment.

FIG. 2H shows the same NOT gate with the input now a one or light on 261 intersecting with the photochromic layer 265. This parallel interaction across the photochromic layer 265 cause the layer to switch or change from transparent to opaque as the photons cause the electrons to move to a higher shell orbit. The light source 262 is now reflected back and stopped 264 from continuing to the output 267 of the photonic switch device. The output Q of the NOT gate is now zero or no light.

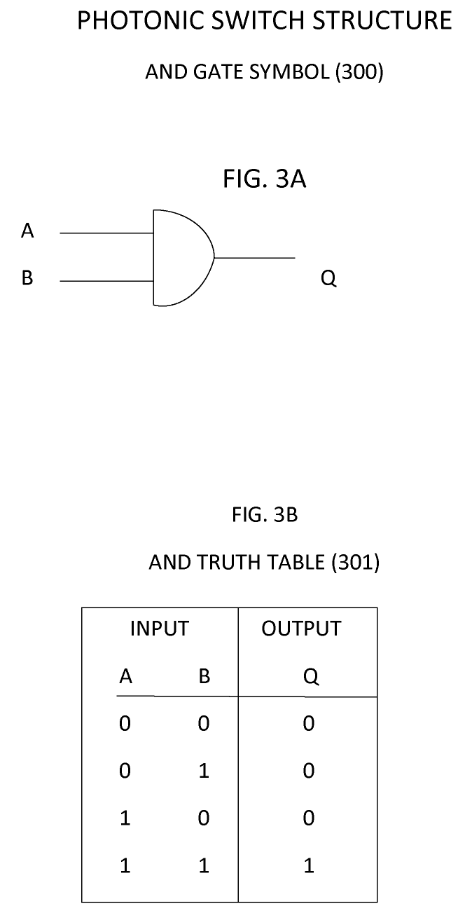

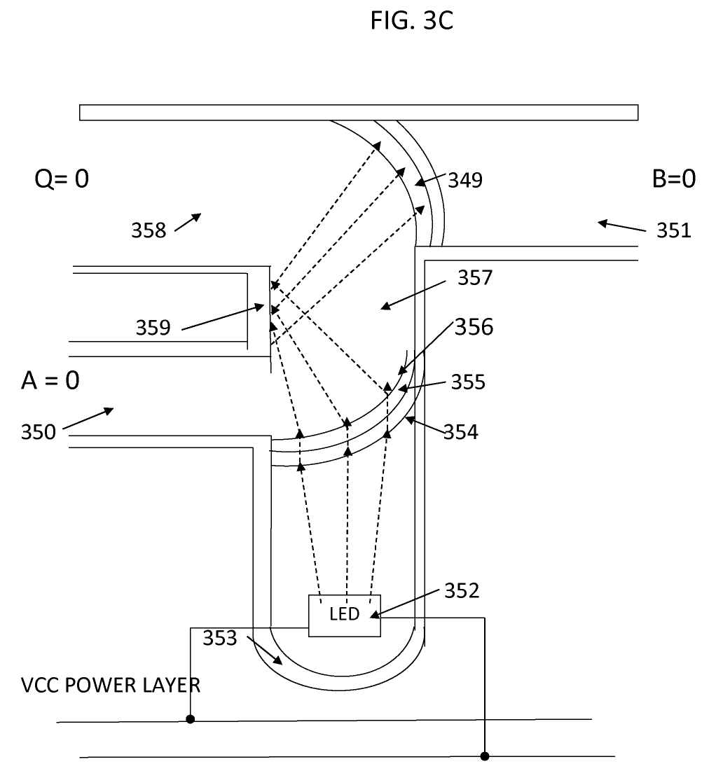

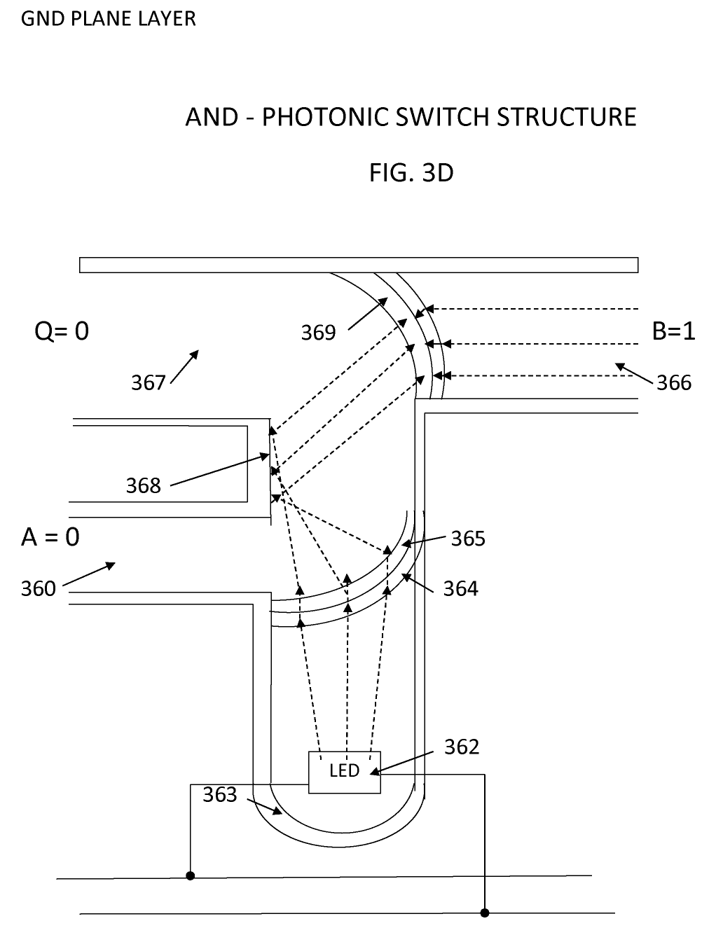

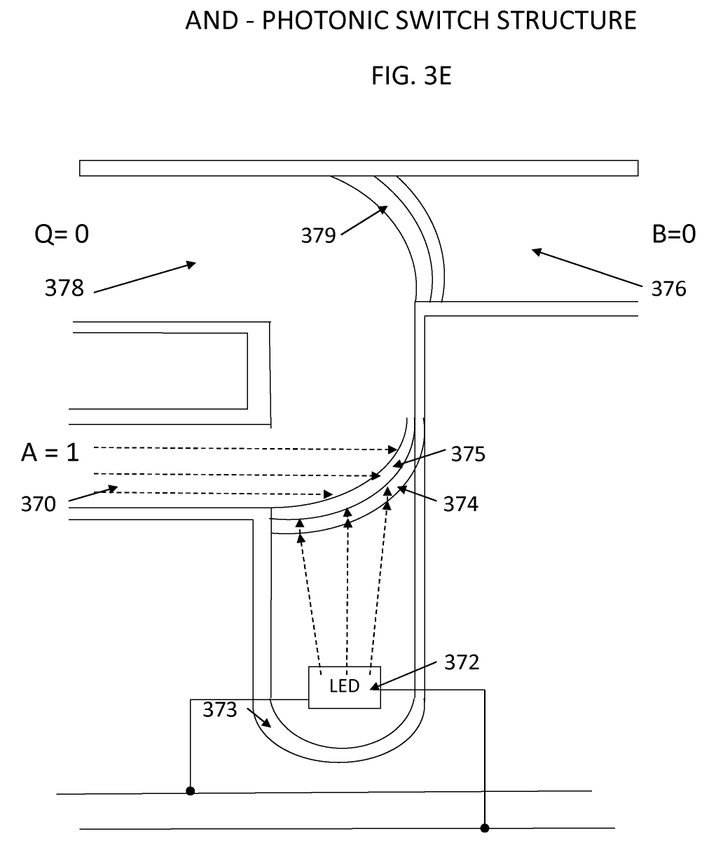

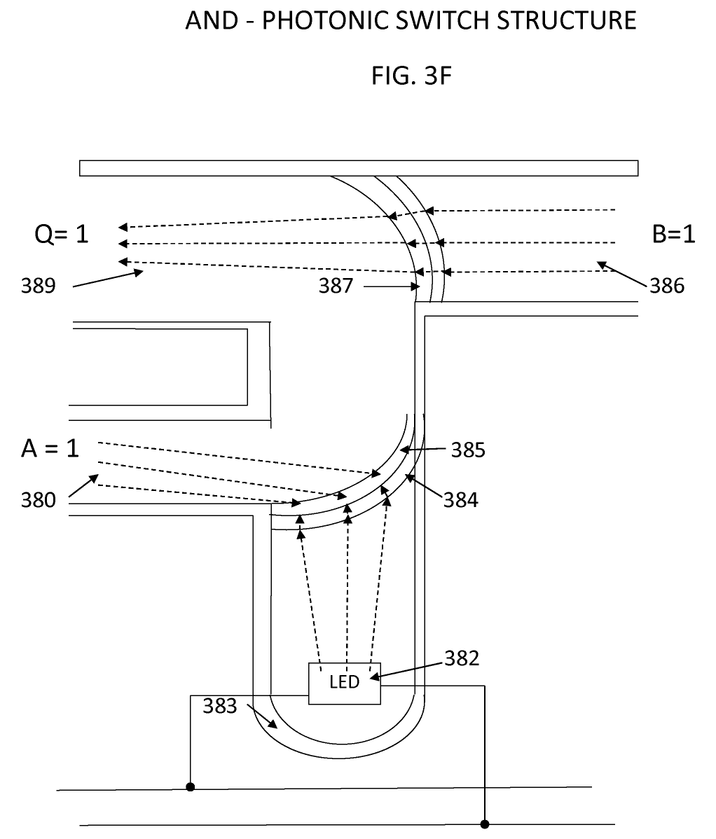

FIG. 3A shows a AND gate 300 with two inputs A and B and one output Q (Prior Art).

FIG. 3B shows the AND gate truth table 301 (prior Art).

FIG. 3C shows a photonic AND gate. Using the first entry in the truth table where both input A 350 and B 351 are zero or off the resulting output is zero of off. The source in this embodiment is a LED 352 which emits EUV radiation which is reflected by reflector 353 upward into the via to pass through the filter 354 and through the photochromic layer 355 which are aligned to allow for the electromagnetic energy to pass through. The light then passes from the photochromic layer 355 to a silicon nitride layer 357 at junction 356 which acts like a lens to focus the light on reflector surface 359. The light then reflects and intersect photochromic layer 349 and is absorbed. This causes no output light 358 and the resulting output is zero.

FIG. 3D shows a Photonic AND gate with using the second line of the truth table where the input 360 A is a zero or off and the second input 366 B is on or one. The light source 363 passes through the filter 364 and then the first photochromic gate 365 and is reflected 368 on to the second gate photochromic 369 which blocks the light source 366 from passing through the gate. The light source 366 (not shown) could be from a light source like a LED or from the output of another photonic device out. The resultant output 367 Q is zero.

FIG. 3E shows a Photonic AND gate with using the third line of the truth table where the input 370 A is a one or on and the second input 376 B is off or zero. The light source 372 is blocked at photochromic layer 375. The input B light source 376 (not shown) could be from a light source like a LED or from the output of another photonic device out, is off or zero and so no light is present. The resultant output 378 Q is zero or off.

FIG. 3F shows a Photonic AND gate with using the fourth line of the truth table where the input 380 A is a one or on and the second input 386 B is on or one. The light source 382 is blocked at the first switch layer 385. The second input light source 386 could be from a light source like a LED or from the output of another photonic device out, is on or one and so light passes through the 387 is present and passes through the 389 photochromic switch layer. The resultant output 389 Q is one or on.

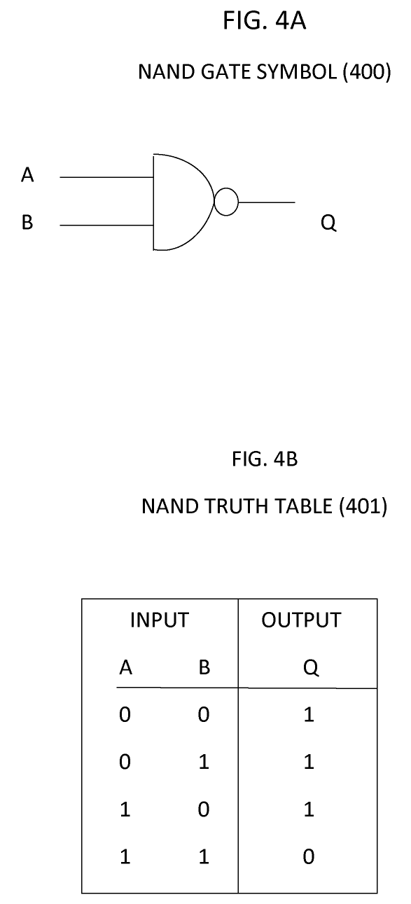

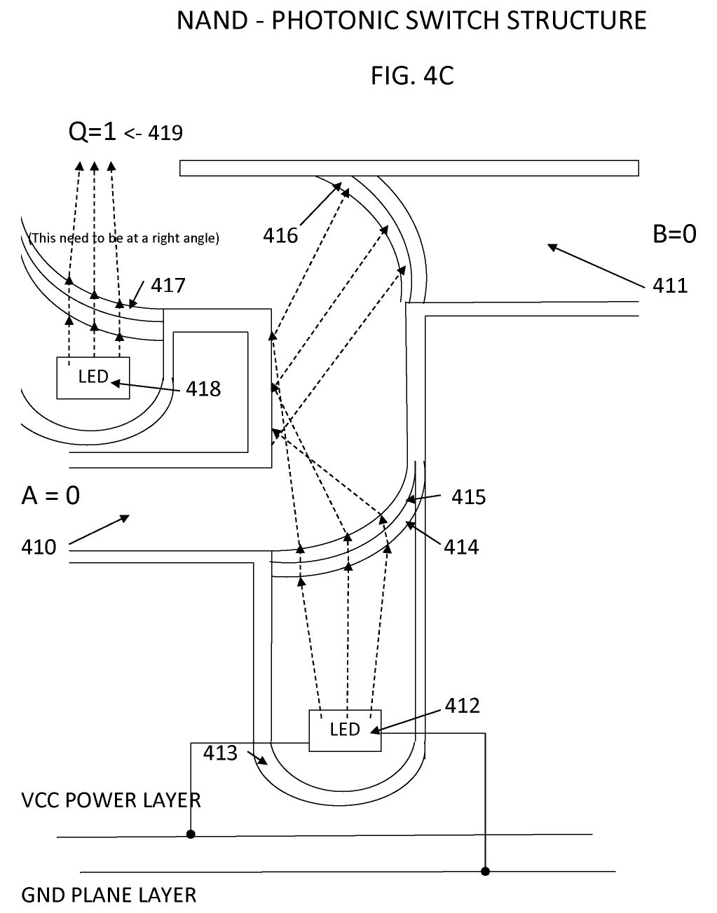

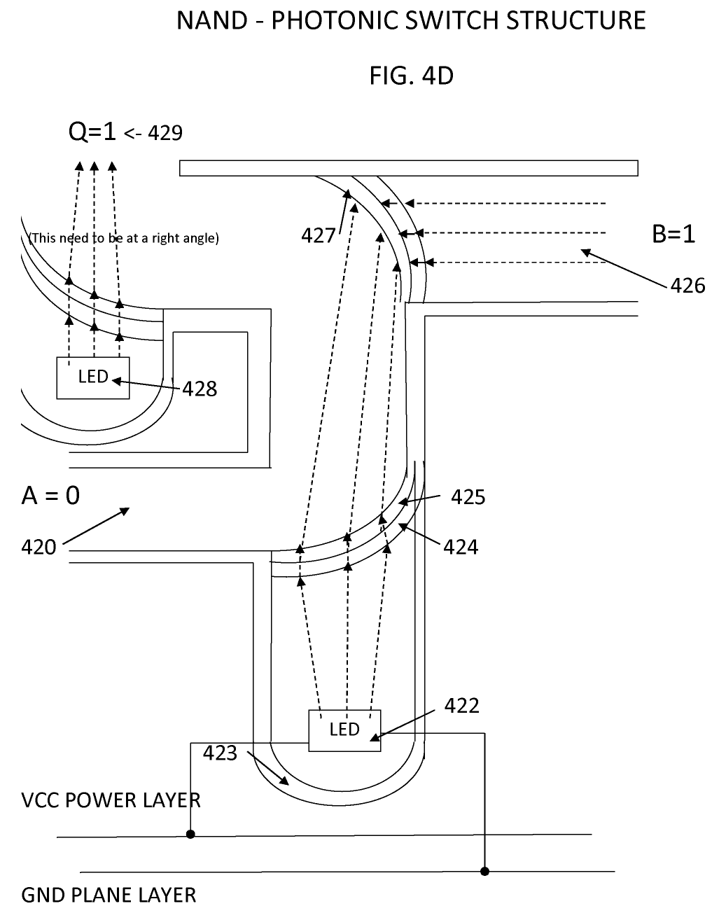

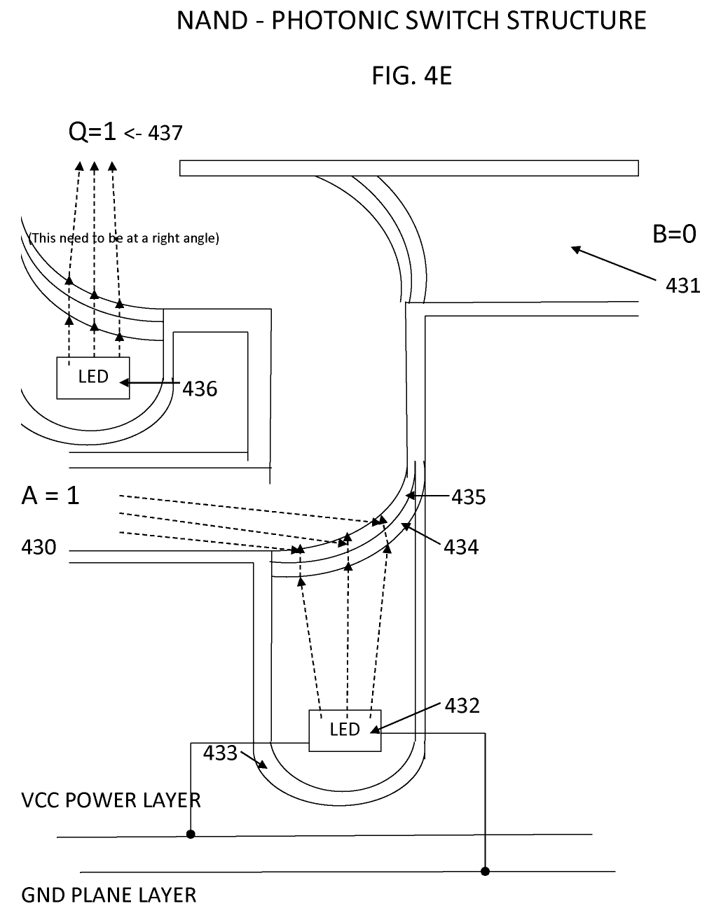

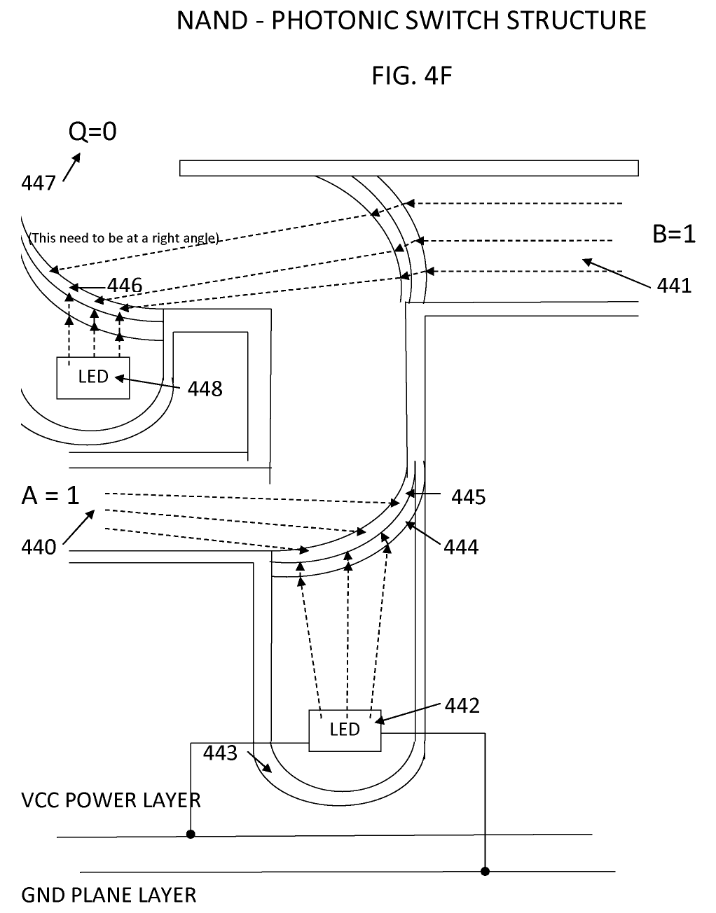

FIG. 4A shows a NAND gate 400 with two inputs A and B and one output Q (Prior Art).

FIG. 4B shows the NAND gate truth table 401 (prior Art).

FIG. 4C shows a photonic NAND gate. Using the first entry in the truth table where both inputs 410 and 411 are zero or off the resulting output is one or on. The source in this embodiment is a LED 412 which emits EUV radiation which is reflected by reflector 413 upward into the via to pass through the filter 414 and through the photochromic layer 415 which are aligned to allow for the electromagnetic energy to pass through. The light then passes from the photochromic layer 415 to the via a silicon nitride layer at junction 415 which acts like a lens to focus the light on reflector surface. The light them reflects and intersect photochromic layer 416 and is absorbed causing the photochromic layer 416 to block any light from passing through. The LED output 418 light passes through the photochromic layer 417 and the resulting output Q 419 is one.

FIG. 4D shows a Photonic NAND gate with using the second line of the truth table where the input 420 A is a zero or off and the second input 426 B is on or one. The light source 422 passes through the first photochromic filter 424 and gate layer 425 and shines on to the second photochromic gate 427 which blocks the light source B 426 from passing through the gate. The light source 428 is shown to be from a light source like a LED 428 or in another embodiment could be from the output of another photonic device output. The resultant output 429 Q is one or on.

FIG. 4E shows a Photonic NAND gate with using the third line of the truth table where the input 430 A is a one or on and the second input 431 B is off or zero. The light source 432 is blocked at gate 435. The light source 436 shown could be from a light source like a LED or from the output of another photonic device output and is on or one and so light is present. The resultant output 437 Q is one or on.

FIG. 4F shows a Photonic NAND gate with using the fourth line of the truth table where the input 440 A is a one or on and the second input 441 B is on or one. The light source 442 is blocked at gate 445. The light source 448 shown could be from a light source like a LED or from the output of another photonic device output and is on or one is blocked by gate 446 by the light from the input B 441 light which passes through and blocks the photochromic gate 446. The light from LED 448 is blocked by 446 photochromic switch layer. The resultant output 447 Q is zero or off.

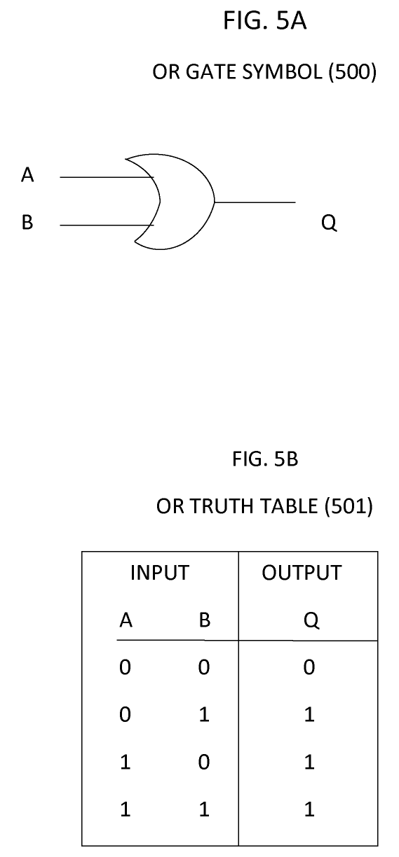

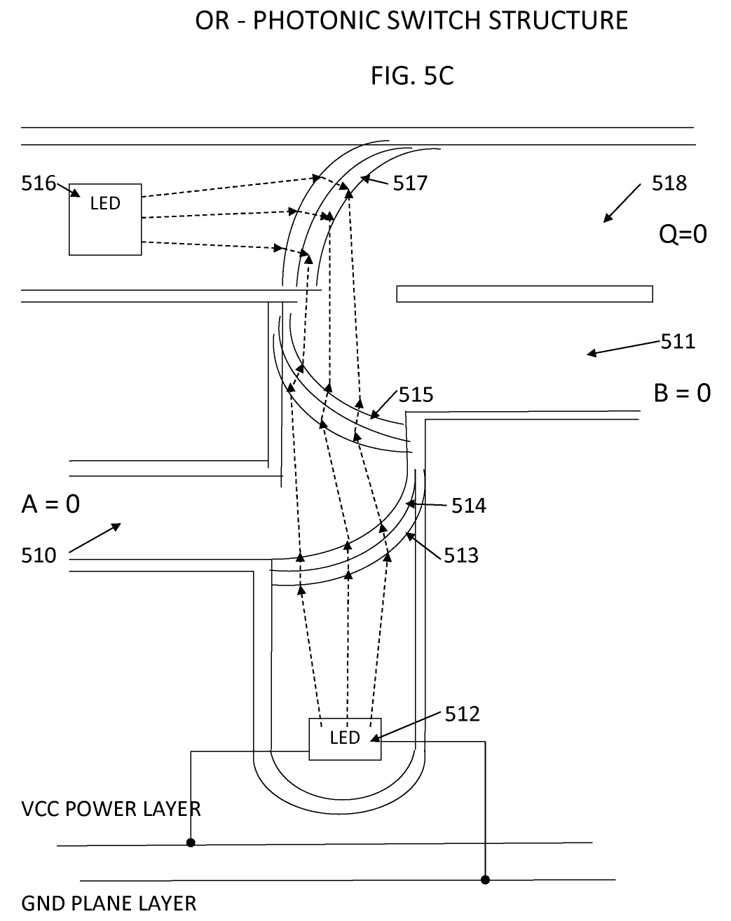

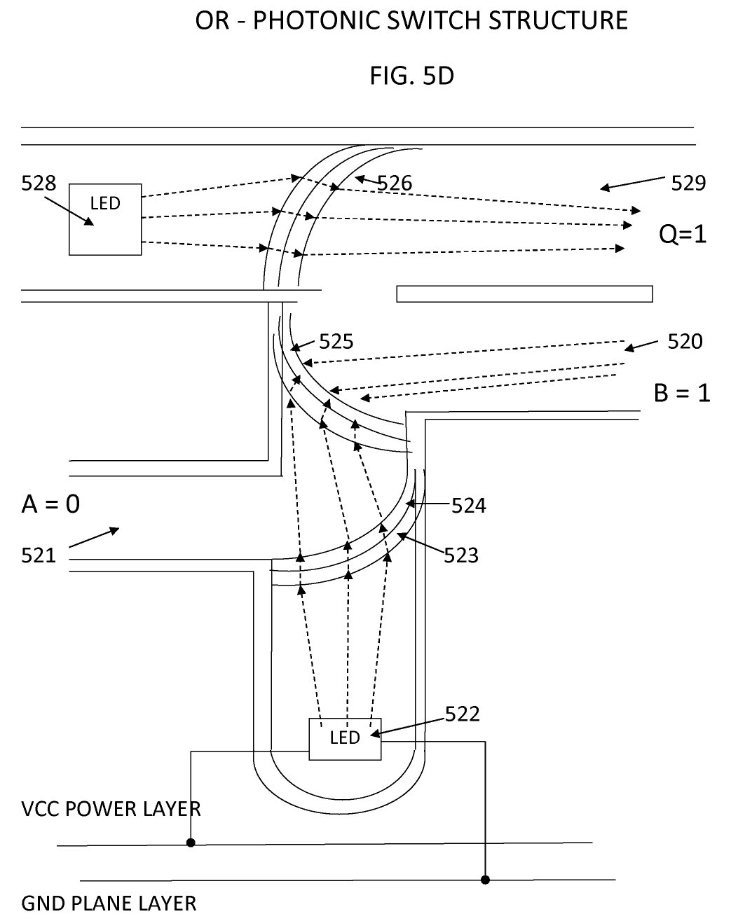

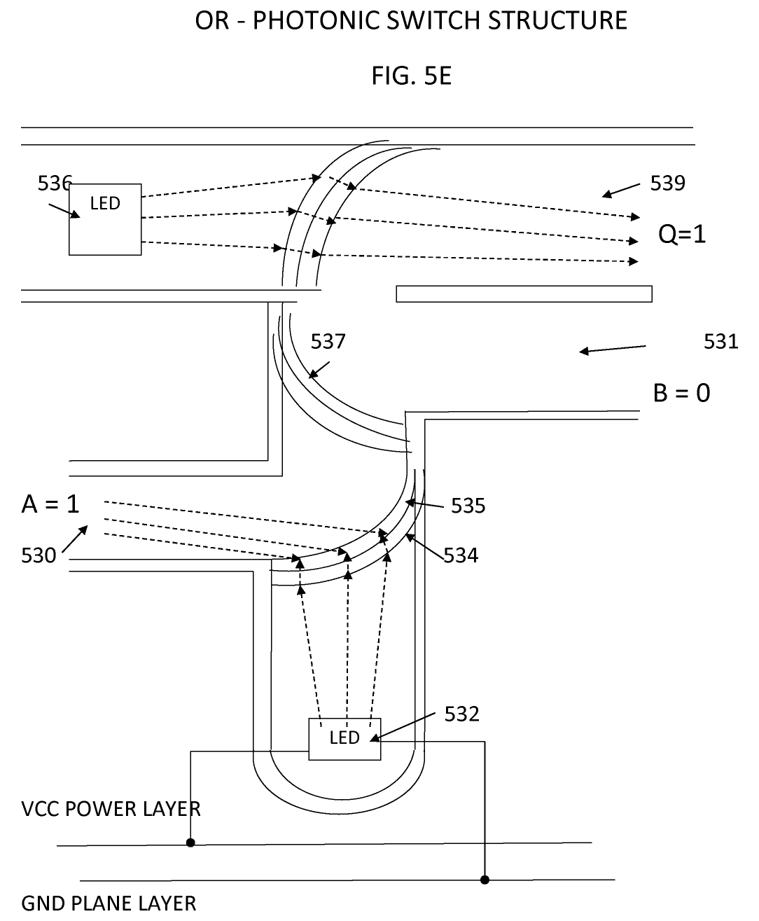

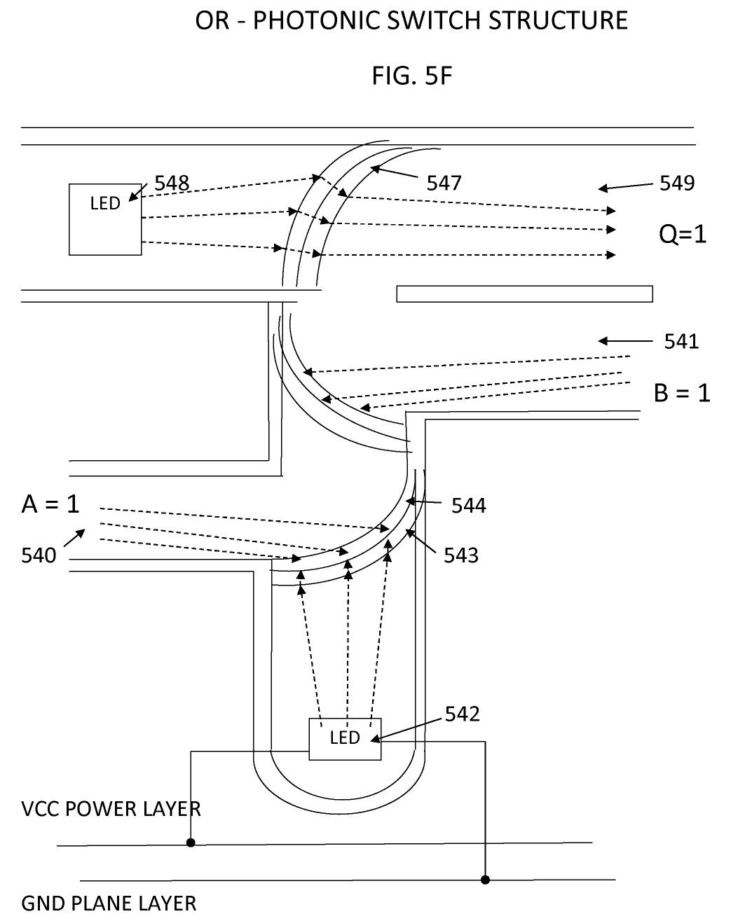

FIG. 5A shows a OR gate 500 with two inputs A and B and one output Q (Prior Art).

FIG. 5B shows the OR gate truth table 501 (prior Art).

FIG. 5C shows a photonic OR gate. Using the first entry in the truth table where both input A 510 and B 511 are zero or off the resulting output is zero or off. The source 512 in this embodiment is a LED 512 which emits radiation which is reflected by reflector upward into the via to pass through the filter 513 and through the photochromic layer 514 which are aligned to allow for the electromagnetic energy to pass through. The light then passes from the photochromic layer 515 to the via a silicon nitride layer at junction 515 which acts like a lens to focus the light the next surface. The light them reflects and intersect photochromic layer 517 and is absorbed causing the photochromic layer 517 to block any light from passing through. The LED output 516 light is blocked from passing through the photochromic layer 517 and the resulting output Q 518 is zero or off.

FIG. 5D shows a Photonic OR gate with using the second line of the truth table where the input 521 A is a zero or off and the second input 520 B is on or one. The light source 522 passes through the first photochromic filter 523 and gate 524 and shines on to the second photochromic gate 525 which blocks the light source B 520 from passing through the gate. The light source 528 shown to be from a light source like a LED or from the output of another photonic device out passes through gate 526 and will result in the output 529 Q is one or on.

FIG. 5E shows a Photonic OR gate with using the third line of the truth table where the input 530 A is a one or on and the second input 531 B is off or zero. The light source 532 is blocked at gate 535 by input 530. The light source 536 shown could be from a light source like a LED or from the output of another photonic device out and is on or one and so light is present. The resultant output 539 Q is one or on. No light enters gate 537 and no input 531 affect the logic results.

FIG. 5F shows a Photonic OR gate with using the fourth line of the truth table where the input 540 A is a one or on and the second input 541 B is on or one. The light source 542 is passes through filter 543 and is blocked at gate 544. The light source 548 shown could be from a light source like a LED or from the output of another photonic device out and is on or one passed through photochromic gate 547. The resultant output 549 Q is one or on.

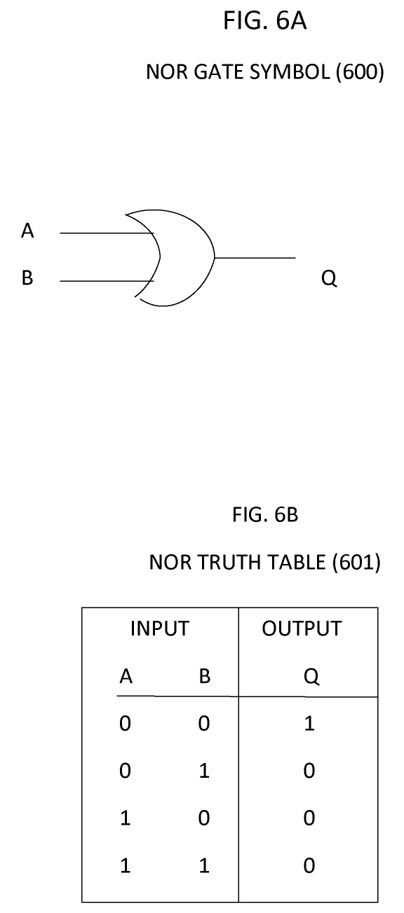

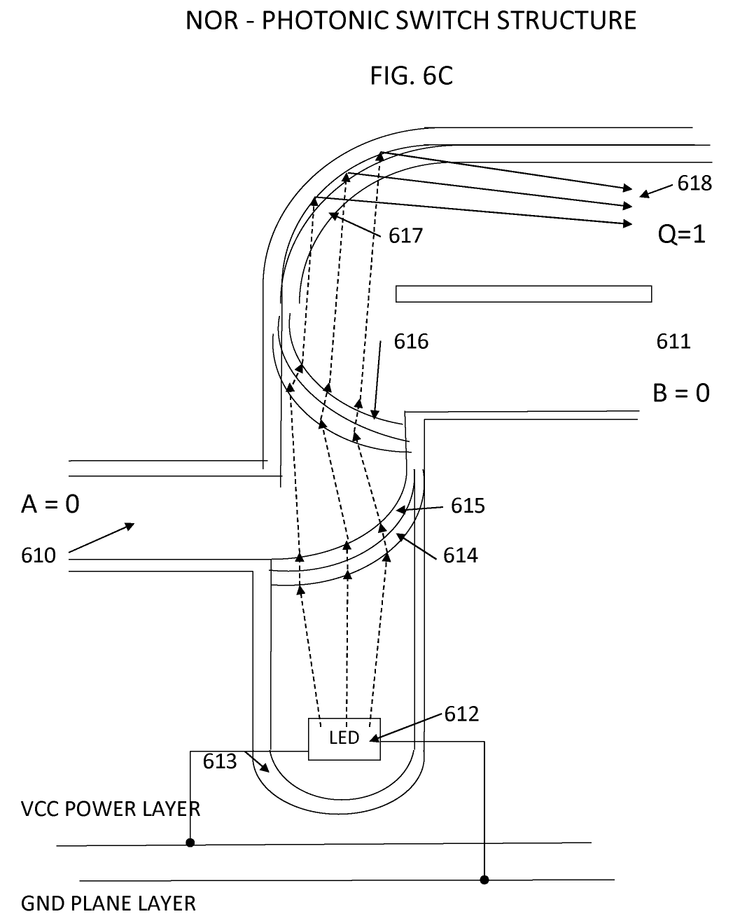

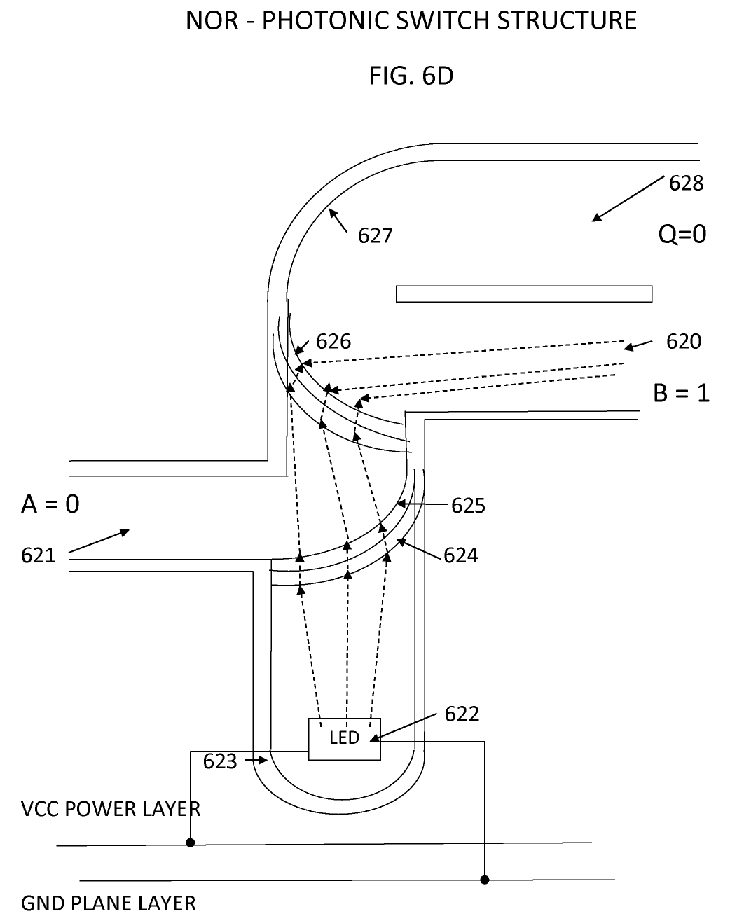

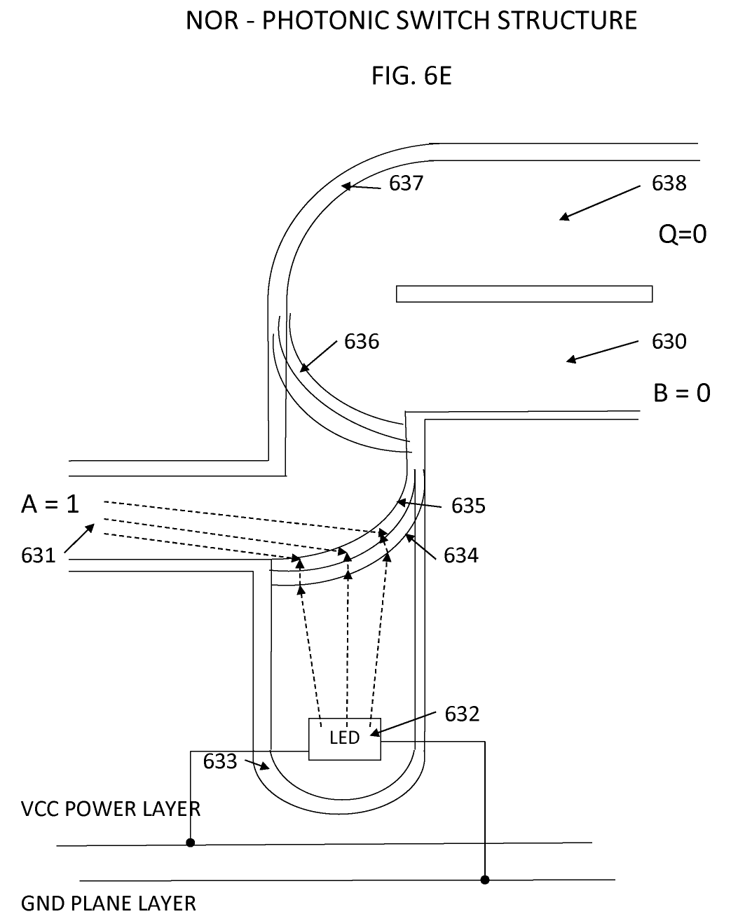

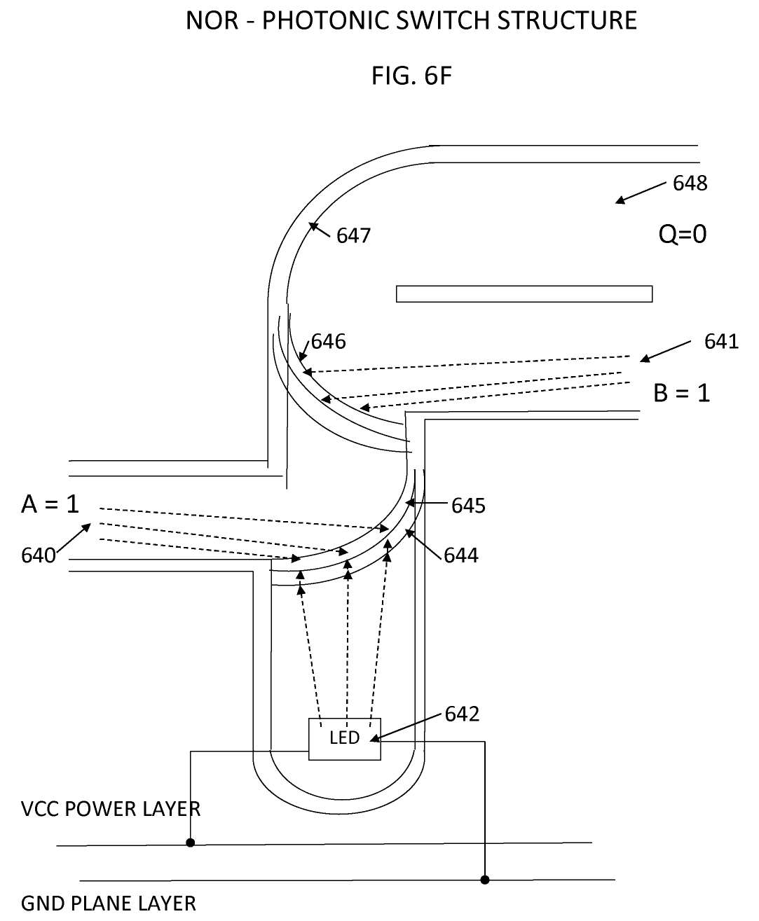

FIG. 6A shows a NOR gate 600 with two inputs A and B and one output Q (Prior Art).

FIG. 6B shows the NOR gate truth table 601 (prior Art).

FIG. 6C shows a photonic NOR gate. Using the first entry in the truth table where both input 610 and 611 are zero or off the resulting output is one or on. The source in this embodiment is a LED 612 which emits EUV radiation which is reflected by reflector 613 upward into the via to pass through the filter 614 and through the photochromic layer 615 which are aligned to allow for the electromagnetic energy to pass through. The light then passes from the photochromic layer 615 to the via a silicon nitride layer at junction 615 which acts like a lens to focus the light the next surface. The light intersect photochromic filter and layer 616 and passes through the photochromic layer 616. The light then reflects off a Bragg like reflector 617 or other mirror like frequency tuned reflector output light is and the resulting output Q 618 is one or on.

FIG. 6D shows a Photonic NOR gate with using the second line of the truth table where the input 621 A is a zero or off and the second input 620 B is on or one. The light source 622 passes through the first photochromic filter 624 and gate 625 and is blocked at the second photochromic gate 626. A input B 620 blocks the light source 622 from passing through the gate 626. The resultant output 628 Q is zero or off.

FIG. 6E shows a Photonic NOR gate with using the third line of the truth table where the input 631 A is a one or on and the second input 630 B is off or zero. The light source 632 is blocked by the gate 635. The light source 631 shown could be from a light source like a LED or from the output of another photonic device out and is on or one and so light is present. This turns off or blocks the light from passing through the gate 635. The resultant output 638 Q is zero or off.

FIG. 6F shows a Photonic NOR gate with using the fourth line of the truth table where the input 640 A is a one or on and the second input 641 B is on or one. The light source 642 is blocked by the input A 640 at photochromic gate 645. The second input B 641 is also on and causes gate 646 to block any light from going through it. No light is reflected off reflector 647 and resultant output 648 Q is zero or off.

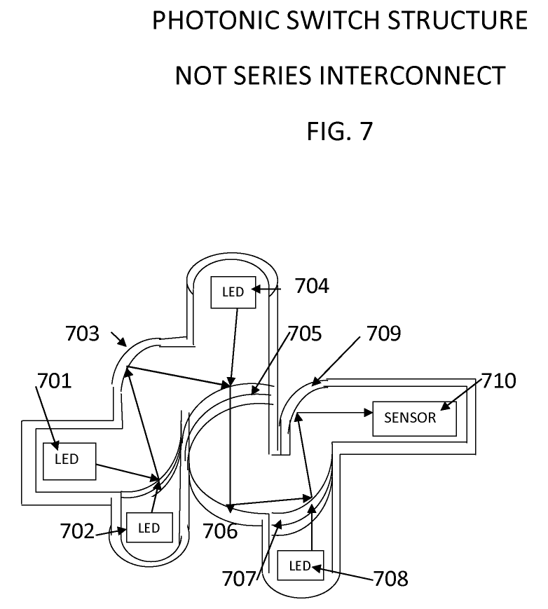

In FIG. 7 shows one embodiment of a complex photonic set of gates or switches routing of the signal waveguides which may require many different layers going up and down to interconnect other switches, sensors, and other component designed in by the designer then additional layer process steps similar to the ones described may be created. This cluster of gates or switches can be used to create complex logic functions for example a adder circuit or other complex logic functions.

Comparing the two logic gate CMOS sizes and footprints need on the silicon wafer surface demonstrates that the photonic device uses as much less space to perform the same logic function. This vertical format allows for many more logic gates to be place in a smaller area on the die. This clustering of gates allow for smaller devices with faster interconnections.

In FIG. 7 starts with either an input pathway or a signal input connected to a LED 701. The signal from this LED 701 can in turned on or block the output from another input or LED 702. The resulting signal can then be reflected by reflector 703 and cause 705 to be switched. Also input or LED 704 can also cause gate 705 to switched allowing for a complex logic gate combination to be created. The result signal can pass through gate 705 and reflect off reflector 706 and onto gate 707. Another LED 708 or input from another gates output feed a signal into pathway 708 which resulting signal is reflected off reflector 709 and into sensor 710. This sensor 710 can be one of many types of sensors like a comb sensor (prior art) for detecting or converting an electromagnetic signal into an electrical signal output.

As many layers of stacked gates can be used to create clusters of gates, for example a circular layout can be created where the final output of a group of logic functions can feed into the input of another stacked circular cluster. An example would be a carry bit output from an adder logic cluster feeding into a input a of the next cluster of a adder, or the carry bit of a shifter register into the next bit shifter register logic gates.

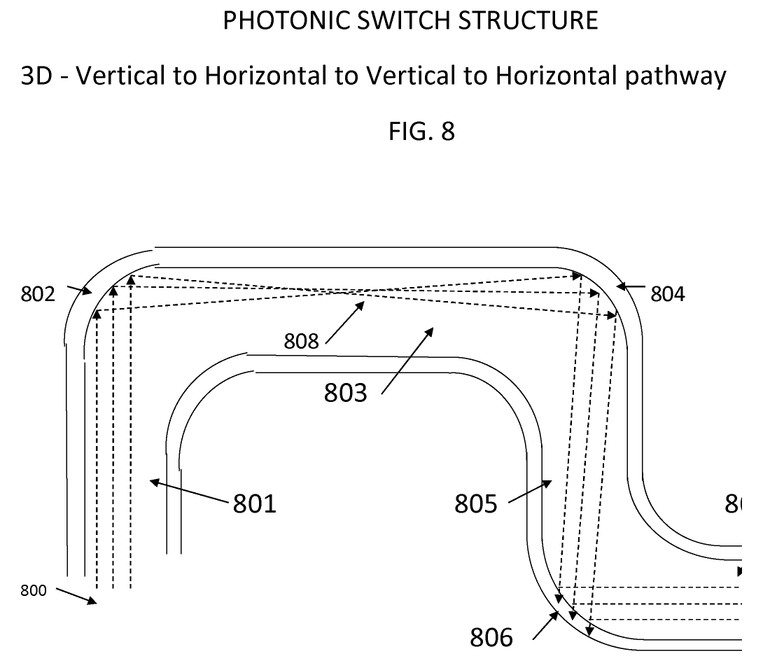

FIG. 8 shows the three dimensional routing of a photonic signal. Like a semiconductor electrical circuit chip where the electrical pathways or wire pathways can go across the chip or up and down through the layers in via’s to connect devices like transistors together, using vertical and horizontal reflectors or signal tuned mirrors allows for pathways to be built to route photonic signals to connect device input and outputs to each other. The pathways using tunnels and sleeves of wavelength reflective material provide a 3D path for the photonic signal. Unlike the electrical pathways in a circuit issues like inductance and capacitive couple noise are not a problem.

Several software tool layout, verification and simulations issues require the software tools to consider the flux signal strength, material absorption values, signal delay timing for pathway lengths, focal point or focus signal strength and side wall reflection losses to name a few are claims as part of this invention and require someone skilled in the art of optical lens, reflectors and fiber optical signaling.

The signal 800 enters a routing pathway 801 going up an optical pathway or via in the layers on the chip. In one embodiment the signal is reflected 802 from an up via 801 to a horizontal layer 803 where the signal focal length may cause the signal focal point 808 to cross and become inverted become unfocused. The signal in one embodiment is reflected from a horizontal direction 803 against a reflector 804 or may become the input to a gate of a photonic device or input to a sensor. In another embodiment the signal may travel down via pathway 805 to another layer within the chip. In one embodiment at the bottom of via 805 input to a photonic device or insects with a reflector 806 and is redirected from a vertical direction to a horizontal direction is any of a number of degrees. The signal 807 is routed to an input of a photonic device (like a gate or sensor). The design of these photonic pathways require design considerations and calculations to ensure that the signal does not become focused on photonic surfaces were the energy buildup could cause heating and cause the destruction of the material.

This invention allows for the electromagnetic pathway or waveguides to be built within an integrated semiconductor to allow for photonic logic elements to be connected within the device. In this embodiment EUV photonic light is uses as a source for the electromagnetic radiation for signaling. Depending upon the frequency of the signaling light or electromagnetic wavelength would cause the size and shape of the pathway or optical tunnel as a person skilled in the art of optical semiconductor would be familiar with.

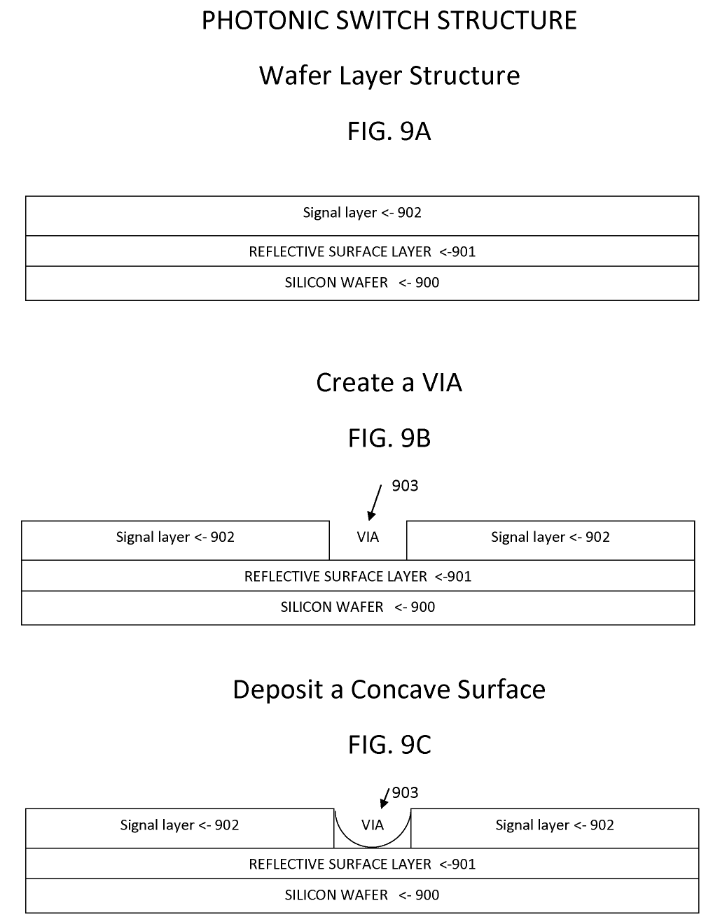

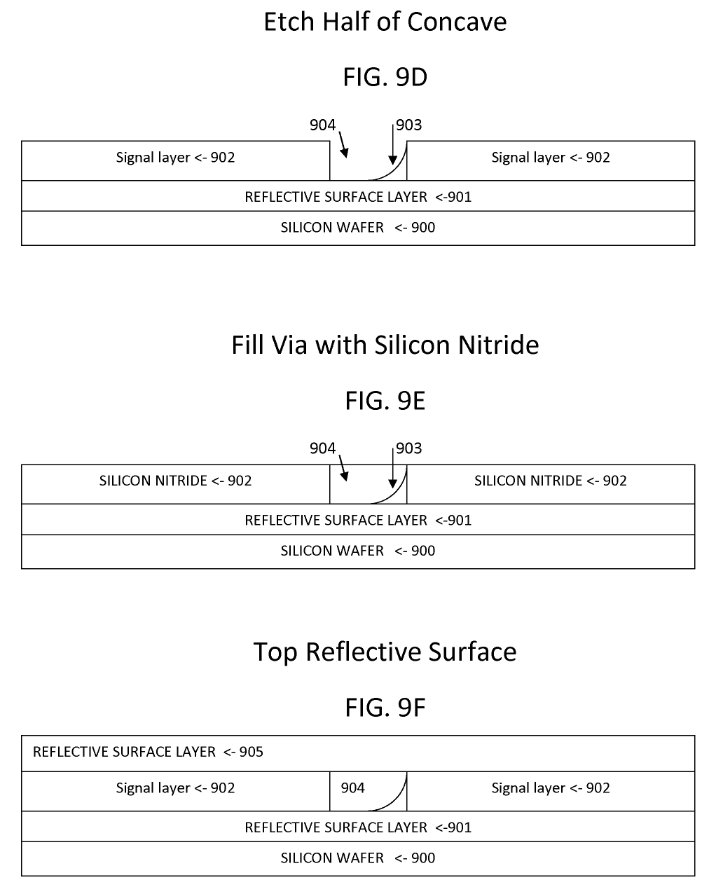

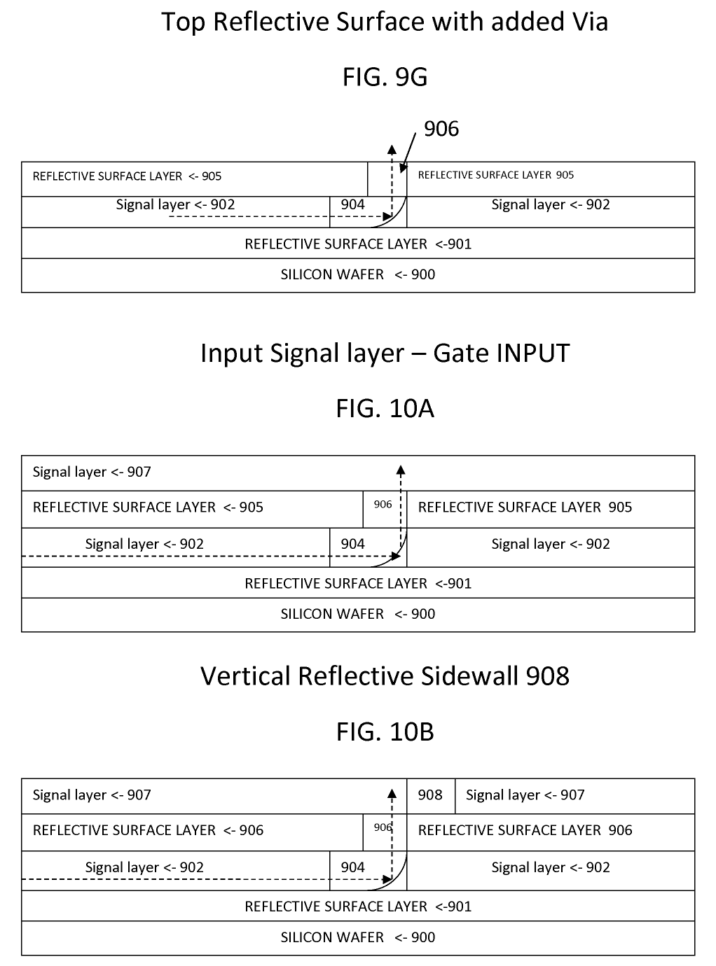

FIG. 9A - A semiconductor side view of a wafer is shown which illustrates the building of a Vertical Photonic Switch (VPS) in accordance with the invention in one embodiment has formed upon a silicon wafer surface 900. A wafer layer structure is deposited using an electromagnetic photo reflective wavelength specific element or a layered Bragg reflector structure 901. This layer could be made up of several different material layers together to build the bottom of a reflective pathway tunnel as would be apparent to the skilled artisan in the arts and design choses from the design tools or someone experience in the semiconductor fabrication process would use. The next layer 902 is a photo conductive or wavelength frequency specific material for example in one embodiment a silicon nitride material. As this material is typical wavelength specific then different combinations or material in different ratios of materials are used to allow for the clearest transparent pathway for the photonic signal with issues like material abortion and sidewall reflections path being part of the design considerations.

FIG. 9B is several steps of photo masking and lithographing to create via 903 through the signal layer. This process sequence of step is used to create a trench (not shown) along the sides of the signal pathway 902 etching to the first or bottom reflective layer to allow for the sidewalls of the pathway tunnel to be deposited next or on the sides of element 902.

In another embodiment the design for different frequencies of electromagnetic radiation may be used for example terahertz microwave waveguides, UV and X-ray radiation waveguide at a different wavelength frequency which would provide for a smaller and faster interconnect signal pathway.

FIG. 9C shows a diagram of photonic switch dome structure 903 is deposited in the via. In one embodiment part of the dome is etched or removed and a reflective material is deposited to allow the electromagnetic signal to be reflected using a frequency specific material and to reflect the signal to go up the via. In another embodiment this dome is used as reflector base with a LED to be deposited or built and to causes the signal from a LED source to be reflected up the via to be later built in additional layers.

This dome shape semiconductor deposition process step using a Phase Rotating (PR) Dual Frequency (DF) Plasma Enhanced (PE) Chemical Vapor Deposition (CVD) semiconductor tool or cluster module as part of a cluster tool processing system is used to deposit this dome shape structure. This PR DF PE CVD system allows for curved surfaces to be deposited on a wafer surface and for atomic layer deposition (ALD) to deposited material on these curved surfaces structures on a wafer surface. The PR-DF-PE-CVD system allows for the radius of these curves structures to be adjusted as per the layout design tools. The Radio Frequency (RF) generators used by the CVD system matching network controls are adjusted the matching RF networks to cause the Dual frequency RF generators to cause a plasma phase rotation or vortex in the dual plasma layers. This vortex or a rotating plasma magnetic fields causing the deposition to fill the corners of the via first and create a concave structure. By adjusting the input gas flows and liquids flow rates, the chamber pressure and the power level and phasing between the RF generators the deposition vortex size and/or height and its rotation speed are controlled to adjust the deposition layer.

FIG. 9D shows the result of a set of semiconductor operations where half of the dome shape has been etched away 904 and removed leaving half of the concave reflector to be used. In another embodiment a reflective material is deposited onto the half dome surface to change or reflect the signal direction and reflect an input signal up a signal transparent via structure to be added in later steps. This deposition may use a Atomic layer deposition process using the PRDFPECVD system.

FIG. 9E shows the via 904 filled with a transparent signal material for example in one embodiment silicon nitride leaving the reflector 903.

FIG. 9F shows the next layer of a reflective material 905 deposited and intersecting with the sidewalls that were deposited around the signal 902 layer forming the top of the pathway tunnel.

FIG. 9G shows a via 906 added through the reflective surface 905.

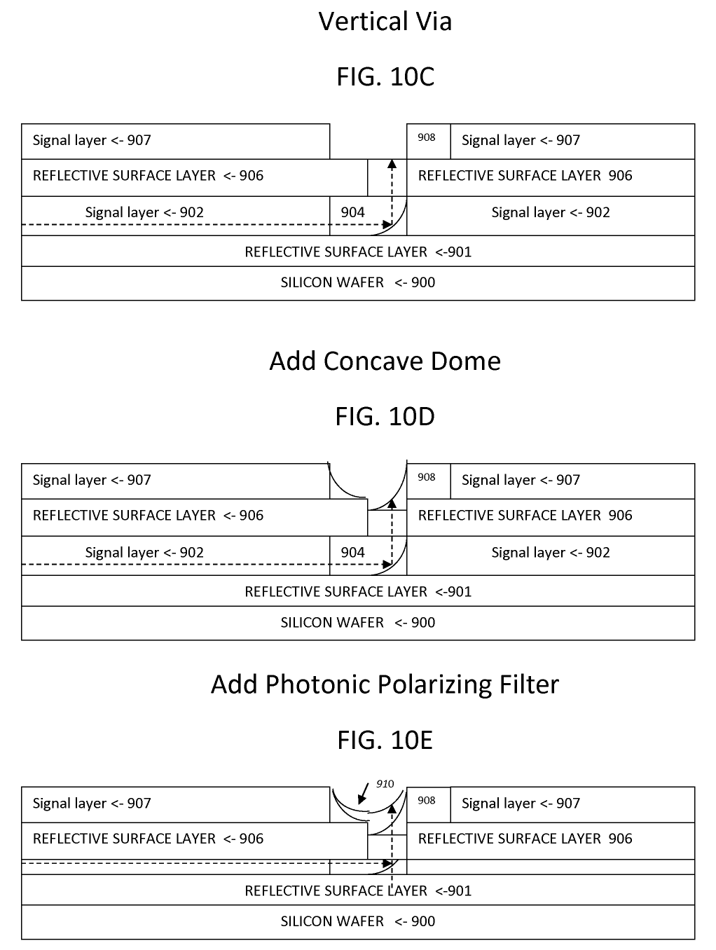

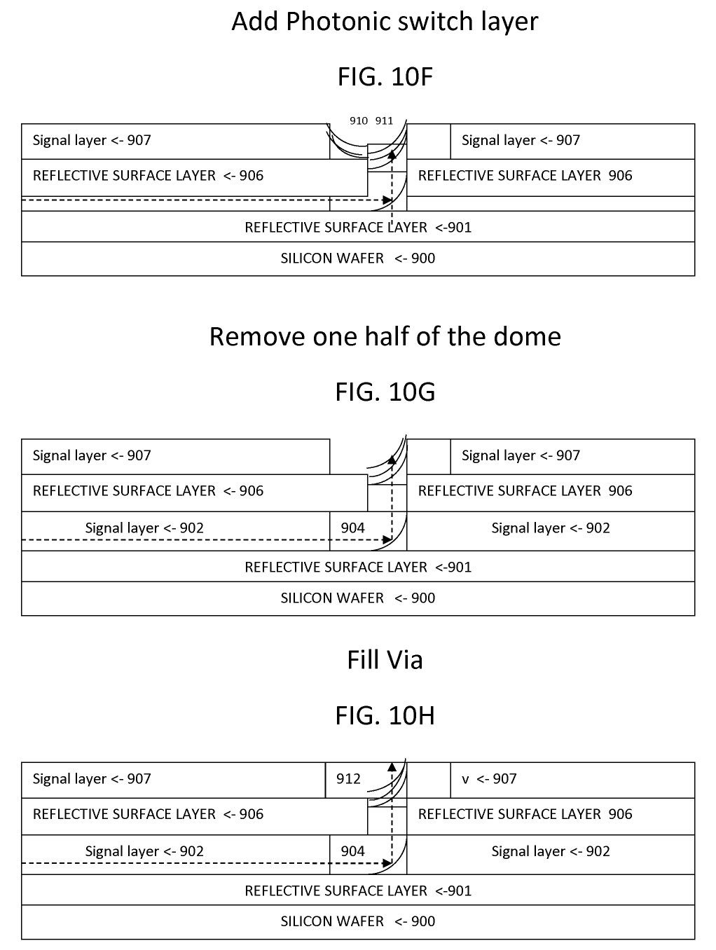

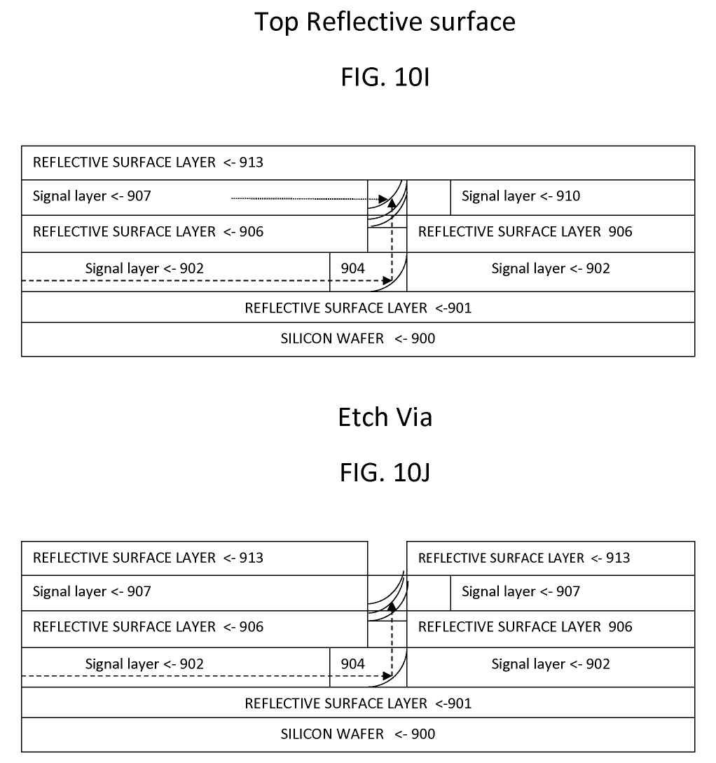

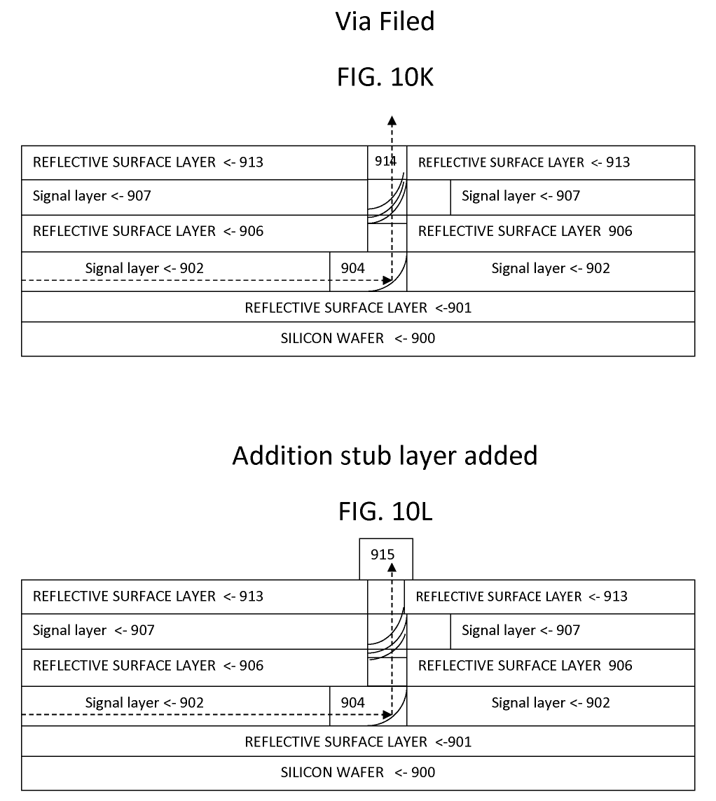

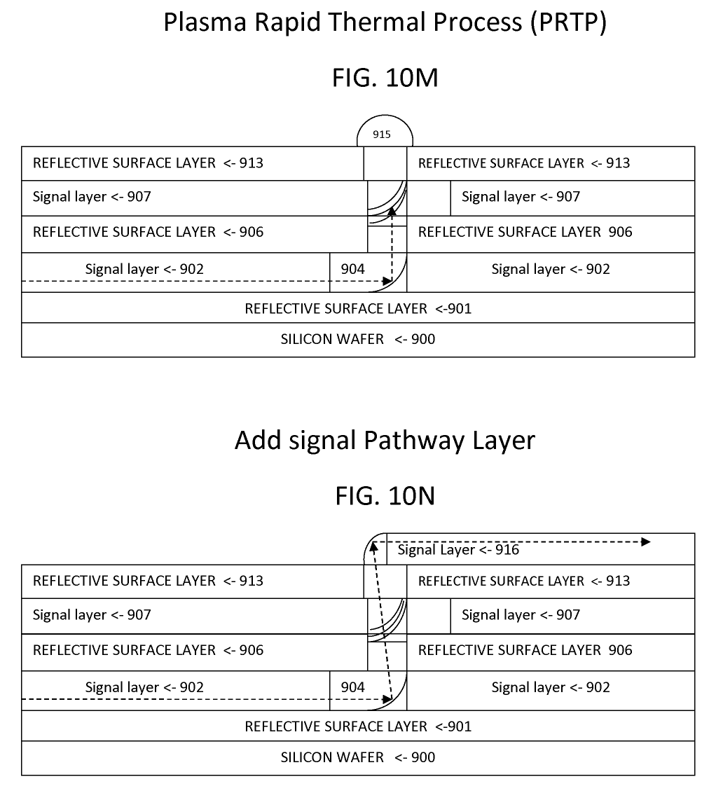

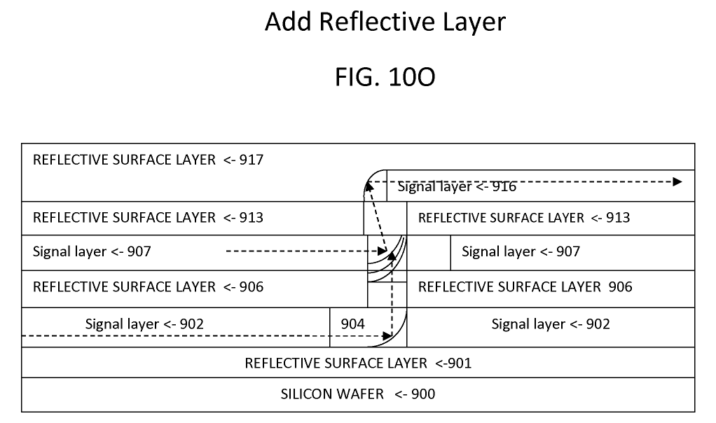

FIG. 10A shows a new signal layer 907 added that will be used as a signal tunnel to the photonic switch. Also via 906 has also been filled with a signal transparent material as part of the signal layer 907 deposition.

FIG. 10B shows the etching and addition of a reflective sidewall 908 is added surrounding the signal layer 907. The 908 sidewalls are etched and a reflective material added into these etched trenches to build the input signal tunnel.

FIG. 10C shows a new trench or via etch into the signal layer 907.

FIG. 10D shows a dome shape deposited into the via using the RP DF PE CVD system.

In one embodiment a deposition material with a wavelength adjusted material to form a polarizing filter is deposited. In another embodiment a signal transparent material is deposited.

FIG. 10E shows the adding of a dome shape signal polarizing filer material 910.

FIG. 10F shows the adding of a dome shape Photochromic switching layer 911.

FIG. 10G shows one half of the dome is etched and removed.

FIG. 10H shows the area is then filled with a signal conducting material 912.

FIG. 10I shows the top reflective layer 913 added.

FIG. 10J shows a via etched in the top reflective layer.

FIG. 10K shows the via 914 is also filled in with the same signal transparent material.

FIG. 10L shows an additional layer 915 of signal transparent material deposited to the top of the signal via and then etched back leaving a stub 915 or small block of signal transparent material.

FIG. 10M shows the resulting stub 915 after plasma rapid thermal process (PRTP) has been applied and caused the stub to become a ball or dome shaped structure. This PRTP process module use a combination of chamber pressure, Radio Frequency RF power levels and gas mixture combination for example in one embodiment hydrogen or nitrogen depending upon the temperature needed to create a surface temperature for the waveguide stub to melt. The surface tension of the material will cause the stub to form a semi ball like structure or a round like top surface. Other higher temperature material for example, in one embodiment tungsten is deposited places over the non-effected surfaces of the wafer to stop the temperature from effecting their structure or chemical makeup. This adds PRTP protective layers can either be left on the wafer or etched or stripped off after the PRTP process is complete.

FIG. 10N shows an additional signal layer 916 masked and added to overlay half of the dome and to extend the signal layer as an output of the photonic gate.

FIG. 10O shows a reflective layer added which causes the photonic signal going up the via to strike a reflective layer 917 and change from a vertical signal to a horizontal signal.

These design layouts require special inputs to the design software for example the Cadence or Synoptic semiconductor layout, verification and simulation software packages as the reflector focal length or the lens focal length are need to calculated to stop any light energy focus spots from focusing on the reflector or switching surface and heating or causing failure points in the photonic circuit.

As show in several figures above, this layering process can be modified to add additional layers to allow for the stacking of multiple photonic switching and routing layer to be added creating complex photonic circuits.

1. An optical switching device comprising:
a semiconductor substrate comprising a plurality of layers defining an optical path configured to transmit electromagnetic radiation at a signal wavelength; and
a photochromic layer positioned within the optical path and configured to transition between a first optical state and a second optical state in response to exposure to electromagnetic radiation at a switching wavelength,
wherein in the first optical state the photochromic layer is transmissive to electromagnetic radiation at the signal wavelength, and in the second optical state the photochromic layer is at least partially opaque to electromagnetic radiation at the signal wavelength.

2. The optical switching device of claim 1, wherein the photochromic layer has at least one of: a concave shape or a dome shape or a curved shape; and wherein a lattice structure of the photochromic layer is configured to:
change responsive to exposure to electromagnetic radiation at the switching wavelength; and
deliver electromagnetic radiation at the switching wavelength to the photochromic layer,
wherein the optical waveguide is positioned transverse to an optical axis of the photochromic layer.

3. The optical switching device of claim 1,
wherein the photochromic layer may be configured as an optical lens and may be comprise at least one of: gallium arsenide, lithium niobate, indium phosphide, and tungsten oxide, or other photo sensitive materials (molecules); and
wherein the photochromic layer has a curved surface configured to receive electromagnetic radiation in parallel across the curved surface.

4. The optical switching device of claim 1, wherein one or more of the signal wavelength and the switching wavelength comprises at least one of:
extreme ultraviolet (EUV) wavelength from about 10 nanometers to about 100 nanometers; or a terahertz wavelengths, or any ultraviolet wavelengths, or an any X-ray wavelengths.

5. The optical switching device of claim 2, wherein the optical switching device is configured as a negative switching device, wherein exposure to electromagnetic radiation at the switching wavelength causes the photochromic layer to transition from the first optical state to the second optical state to block electromagnetic radiation at the signal wavelength.

6. The optical switching device of claim 1, wherein
the semiconductor layer which has a via extending through at least a portion of the semiconductor layers and or substrate;
the photochromic layer is positioned within the via, wherein the photochromic layer is configured to transition between a transmissive state and an opaque state;
an optically transparent material is positioned within the via; and
a reflective material surrounding at least a portion of the optically transparent material to form a wave guide or light pipe.

7. The optical switching device of claim 6, wherein the photochromic layer has an at least approximately curved shape; wherein the photochromic layer is positioned at least approximately coaxially with an axis of the wave guide or light pipe; and wherein the photochromic layer is configured to block electromagnetic radiation by transitioning to an opaque state.

8. The optical switching device of claim 6, further comprising:
a curved reflector positioned within the via and configured to redirect electromagnetic radiation propagating through the wave guide or light pipe.

9. A photonic logic gate comprising:
a first photochromic switching layer embedded in a semiconductor device layer configured to transition between a transparent state and an opaque state in response to an optical switching signal;
an optical source configured to emit electromagnetic radiation along an optical axis;
a first curved reflector positioned to direct the electromagnetic radiation from the optical source toward the photochromic switching layer;
an optical input waveguide configured to deliver the optical switching signal to the photochromic switching layer; and
an optical output waveguide configured to receive electromagnetic radiation that passes through the photochromic switching layer when the photochromic switching layer is in the transparent state.

10. The photonic logic gate of claim 9, wherein the photonic logic gate is configured as at least one of: a NOT gate, an AND gate, a NAND gate, an OR gate, or a NOR gate, and wherein:
(i) for the NOT gate, the optical switching signal causes the photochromic switching layer to transition to the opaque state and block electromagnetic radiation from the optical source;
(ii) for the AND gate or the NAND gate, the photonic logic gate further comprises a second photochromic switching layer vertically stacked with the first photochromic switching layer; and
(iii) for the OR gate or the NOR gate, the photonic logic gate further comprises a second photochromic switching layer and a second optical source.

11. The photonic logic gate of claim 9, wherein the photochromic switching layer has at least one of: a concave or curved shape, the curved shape having a curved surface configured to receive photons from the optical switching signal in parallel across the curved surface, and wherein the photochromic switching layer comprises one material like: gallium arsenide, or lithium niobate, or indium phosphide, or tungsten oxide, or a similar photo wavelength sensitive material or a combination thereof.

12. The photonic logic gate of claim 9, wherein the electromagnetic radiation comprises extreme ultraviolet (EUV) light having a wavelength from about 10 nanometers to about 100 nanometers, and wherein the optical input waveguide and the optical output waveguide each comprise a silicon nitride material or similar wavelength conducting core surrounded by a reflective material.

13. The photonic logic gate of claim 9, wherein the first curved reflector may comprise a Bragg reflector, or other similar type of reflectors designs and further comprising a polarizing filter positioned between the optical source and the photochromic switching layer.

14. The photonic logic gate of claim 9, wherein the photochromic switching layer, the first curved reflector, and the optical input waveguide are vertically integrated within layers of a semiconductor structure.

15. A photonic integrated circuit comprising:
a semiconductor device;
a plurality of photonic switches formed in layers in or above the semiconductor substrate, each photonic switch comprising a photochromic material configured to transition between a transparent state and an opaque state;
a plurality of optical waveguides connecting outputs of at least some of the photonic switches to inputs of other photonic switches, wherein the optical waveguides comprise vertical waveguide pathway structures and horizontal waveguide pathway structures; and
a plurality of curved reflectors positioned at intersections of the vertical via or pathway structures and the horizontal pathway structures.

16. The photonic integrated circuit of claim 15, wherein at least two of the photonic switches are vertically stacked within a single vertical via structure; wherein the plurality of photonic switches are arranged in a cluster configuration with optical signals routed between the photonic switches through the curved reflectors; and wherein the plurality of photonic switches are configured to form at least one of: an arithmetic logic unit, or a flip-flop circuit comprising cross-coupled photonic switches, or a ring oscillator.

17. The photonic integrated circuit of claim 15, wherein the photochromic material comprises a material having a lattice structure that changes responsive to exposure to electromagnetic radiation, the material includes at least one of: gallium arsenide, lithium niobate, indium phosphide, tungsten oxide, or other similar photo sensitive material.

18. The photonic integrated circuit of claim 15, wherein the vertical via structures comprise reflective sidewalls formed from aluminum, tungsten, molybdenum or other frequency specific wavelength reflective material.

19. The photonic integrated circuit of claim 15, further comprising an optical waveguide structure comprising:
a horizontal waveguide portion comprising an optically transparent core and a reflective material surrounding the optically transparent core;
a vertical waveguide or via portion comprising an optically transparent core and reflective sidewalls surrounding the optically transparent core of the vertical via portion; and
a curved reflector positioned at an intersection of the horizontal waveguide portion and the vertical via portion, the curved reflector configured to redirect optical signals between the horizontal waveguide portion and the vertical via portion.

20. The photonic integrated circuit of claim 19, wherein the curved reflector comprises at least one of:
a half-dome shape;
a Bragg reflector having one to multiple layers of reflective material; or
layers of molybdenum and silicon configured to reflect extreme ultraviolet light;
and wherein the curved reflector has a radius of curvature configured to produce a focal point at a predetermined location along an optical path.

21. The photonic integrated circuit of claim 19, wherein:
the reflective sidewalls comprise aluminum, tungsten, or molybdenum and similar wavelength specific reflective material ; and
the optically transparent core of the horizontal waveguide portion and the optically transparent core of the vertical via portion comprise silicon nitride or other frequencies specific transparent materials.

22. The photonic integrated circuit of claim 19, further comprising a second curved reflector positioned at a second intersection, wherein the optical waveguide structure is configured to route optical signals from a first vertical via portion to the horizontal waveguide portion and from the horizontal waveguide portion to a second vertical via portion.

23. The photonic integrated circuit of claim 15, wherein the photonic integrated circuit is configured as a photonic processor comprising:
a plurality of photonic logic gates, each photonic logic gate comprising a photochromic switching layer configured to transition between a transparent state and an opaque state in response to an optical input signal;
a plurality of optical waveguides interconnecting the photonic logic gates;
an optical clock circuit configured to provide timing signals to the photonic logic gates; and
an electrical interface configured to convert between optical signals and electrical signals.

24. The photonic integrated circuit of claim 23, further comprising at least one of:
a photonic memory connected to the plurality of photonic logic gates via an optical bus; or
a cache memory comprising photonic storage elements.

25. The photonic integrated circuit of claim 23, wherein the plurality of photonic logic gates are configured to form an arithmetic logic unit and are arranged in multiple vertically stacked layers.

26. The photonic integrated circuit of claim 23, further comprising a photonic input/output interface configured to communicate with external devices using optical signals, wherein the electrical interface comprises an optical-to-electrical converter and an electrical-to-optical converter.

27. The photonic integrated circuit of claim 15, wherein the photonic integrated circuit comprises a photonic oscillator circuit including:
a single or plurality of photonic inverters arranged in a feedback loop, each photonic inverter comprising a photochromic switching layer configured to transition between a transparent state and an opaque state; and
optical waveguides connecting an output of the photonic inverter to an input of the same or another subsequent photonic inverter,
wherein an output of a last photonic inverter may be connected to an input of a first photonic inverter.

28. The photonic integrated circuit of claim 27, wherein the single or a plurality of photonic inverters comprises an odd number of photonic inverters configured as a ring oscillator, and wherein an oscillation frequency is determined by optical path lengths of the optical waveguides and switching times of the photochromic switching layers.

29. The photonic integrated circuit of claim 27, further comprising an output waveguide coupled to one of the photonic inverters and configured to provide an oscillating optical signal to a photonic logic circuit.

30. The photonic integrated circuit of claim 27, wherein each photochromic switching layer has a curved surface and comprises gallium arsenide, lithium niobate, indium phosphide, tungsten oxide, or a combination thereof or a similar photo sensitive material.

31. The photonic integrated circuit of claim 15, wherein a semiconductor layout of the photonic integrated circuit is generated using a design method comprising:
receiving a circuit design comprising photonic logic gates;
placing photonic switching elements within a semiconductor layout;
routing optical waveguides between the photonic switching elements; and
generating mask data for fabricating the semiconductor layout.

32. The photonic integrated circuit of claim 31, wherein the design method further comprises:
displaying a circuit schematic symbol representing a photonic switching element, the schematic symbol comprising an optical input, an optical output, and an optical switching input.

33. A method of forming a curved optical structure in a semiconductor device, the method comprising:
forming a via in a semiconductor layer;
introducing a deposition gas into a plasma chamber containing a semiconductor wafer with a via in its substrate or within its layers;
generating a dual-frequency plasma using a first radio frequency generator operating at a first radio frequency and a second radio frequency generator operating at a second radio frequency, wherein the first radio frequency is different from the second frequency;
controlling the phase relationship between the first radio frequency and the second radio frequency to create a rotating plasma vortex; and
depositing material from the plasma into the via, wherein the rotating plasma vortex causes preferential deposition in corners of the via to form a concave structure.

34. The method of claim 33, further comprising controlling formation of the rotating plasma vortex by adjusting at least one of:
a phase relationship between the first radio frequency generator and the second radio frequency generator to control a size of the rotating plasma vortex;
power levels of the first radio frequency generator and the second radio frequency generator to adjust a rotation speed of the rotating plasma vortex;
a gas flow rate to adjust a deposition rate of the material; or
a chamber pressure during depositing,
wherein the phase relationship between the first radio frequency and the second radio frequency is controlled to cause the rotating plasma vortex to preferentially deposit material in corners of the via before depositing material on sidewalls of the via.

35. The method of claim 33, further comprising depositing a reflective material on the concave structure to form a curved reflector.

36. The method of claim 33, further comprising depositing a photochromic material on the concave structure, wherein the depositing comprises atomic layer deposition, and wherein the photochromic material may comprise gallium arsenide, lithium niobate, indium phosphide, tungsten oxide, or other photo sensitive material or a combination thereof.

37. The method of claim 33, wherein the deposited material comprises silicon nitride or similar wavelength optical transparent materials.

38. A method of forming a curved optical element, the method comprising:
depositing a column of optically transparent material extending above a surface of a semiconductor structure;
depositing a protective layer over portions of the semiconductor structure while leaving the column exposed; and
exposing the column to a plasma rapid thermal process to heat the column above a melting point of the optically transparent material, wherein surface tension causes the column to form a dome-shaped structure.

39. The method of claim 38, wherein the optically transparent material comprises for example silicon nitride or other wavelength specific transparent material and the protective layer comprises for example tungsten or other high temperature material.

40. The method of claim 38, wherein the plasma rapid thermal process heats the column to a temperature greater than about 1,900 °C.

41. The method of claim 38, further comprising controlling at least one of a chamber pressure, a radio frequency power level, or a gas mixture to control a radius of the dome-shaped structure, and further comprising etching a portion of the dome-shaped structure to form a half-dome reflector.

42. The method of claim 38, wherein the dome-shaped structure forms an optical lens and further comprising at least one of:
depositing a reflective coating on the dome-shaped structure; and
depositing a photochromic material on the dome-shaped structure.
